(19) United States
(12) Patent Application Publication
(10) Pub. No.: US 2026/0266239 A1
(43) Pub. Date: Sep. 10, 2026

(54) GAS TURBINE ENGINE

(71) Applicant: General Electric Company, Evendale, OH (US)

(72) Inventors: Brandon Wayne Miller, Middletown, OH (US); Randy M. Vondrell, Newport, KY (US); David Marion Ostdiek, Liberty Township, OH (US); Craig William Higgins, Liberty Township, OH (US); Alexander Kimberley Simpson, Cincinnati, OH (US); Syed Arif Khalid, West Chester, OH (US); Andrew Breeze-Stringfellow, Montgomery, OH (US)

(21) Appl. No.: 19/003,701

(22) Filed: Dec. 27, 2024

Related U.S. Application Data
(63) Continuation-in-part of application No. 18/888,873, filed on Sep. 18, 2024, now Pat. No. 12,410,763.
Application No. 18/888,873 is a continuation-in-part of application No. 18/675,270, filed on May 28, 2024, now Pat. No. 12,523,188.
Application No. 18/675,270 is a continuation of application No. 17/879,384, filed on Aug. 2, 2022, now Pat. No. 12,031,504.

(51) Int. Cl. F02K 3/065; F02C 3/06

(52) U.S. Cl. CPC F02K 3/065; F02C 3/06

(57) ABSTRACT

A gas turbine engine is provided. The gas turbine engine includes a turbomachine defining an engine inlet to an inlet duct, a fan duct inlet to a fan duct, and a core inlet to a core duct; a primary fan driven by the turbomachine; and a secondary fan located downstream of the primary fan within the inlet duct. The gas turbine engine defines a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct.

### CROSS-REFERENCE TO RELATED APPLICATIONS

This application is a continuation in part application of U.S. application Ser. No. 18/888,873, filed Sep. 18, 2024, which is a continuation in part application of U.S. application Ser. No. 18/675,270, filed May 28, 2024, which is a continuation application of U.S. application Ser. No. 17/879,384 filed Aug. 2, 2022. Each of these applications is hereby incorporated by reference in their entireties.

### FIELD

The present disclosure relates to a gas turbine engine with a third stream.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a three-stream engine in accordance with an exemplary embodiment of the present disclosure.

FIG. 2 is a close-up, schematic view of the exemplary three-stream engine of FIG. 1.

FIG. 3 is a close-up view of an area surrounding a leading edge of a core cowl of the exemplary three-stream engine of FIG. 2.

FIGS. 4A through 4H are tables depicting numerical values showing the relationships between various parameters in accordance with various example embodiments of the present disclosure.

FIGS. 5A through 5D are graphs depicting a range of thrust to power airflow ratios and core bypass ratios in accordance with various example embodiments of the present disclosure.

FIG. 6 is a schematic view of a turboprop engine in accordance with an exemplary aspect of the present disclosure.

FIG. 7 is a schematic view of a direct drive, ducted, turbofan engine in accordance with an exemplary aspect of the present disclosure.

FIG. 8 is a schematic view of a geared, ducted, turbofan engine in accordance with an exemplary aspect of the present disclosure.

FIG. 9 is a schematic view of a geared, ducted, turbofan engine in accordance with another exemplary aspect of the present disclosure.

FIG. 10 is a schematic view of an unducted gas turbine engine in accordance with another exemplary aspect of the present disclosure.

FIG. 11 is a schematic view of an unducted gas turbine engine in accordance with yet another exemplary aspect of the present disclosure.

FIG. 12 is a schematic view of an unducted gas turbine engine in accordance with still another exemplary aspect of the present disclosure.

FIG. 13 is a schematic, cross-sectional view of a gas turbine engine in accordance with an exemplary aspect of the present disclosure.

FIG. 14 is a forward-looking-aft view of a rotor assembly in accordance with an exemplary embodiment of the present disclosure as may be incorporated into the gas turbine engine of FIG. 13.

FIG. 15 is a plan view along a radial direction of three exemplary rotor blade configurations.

FIG. 16 is a graph of exemplary advance ratio values of an engine in accordance with the present disclosure.

FIG. 17 is a flow diagram of a method for operating a single unducted rotor engine in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The phrases “from X to Y” and “between X and Y” each refers to a range of values inclusive of the endpoints (i.e., refers to a range of values that includes both X and Y).

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

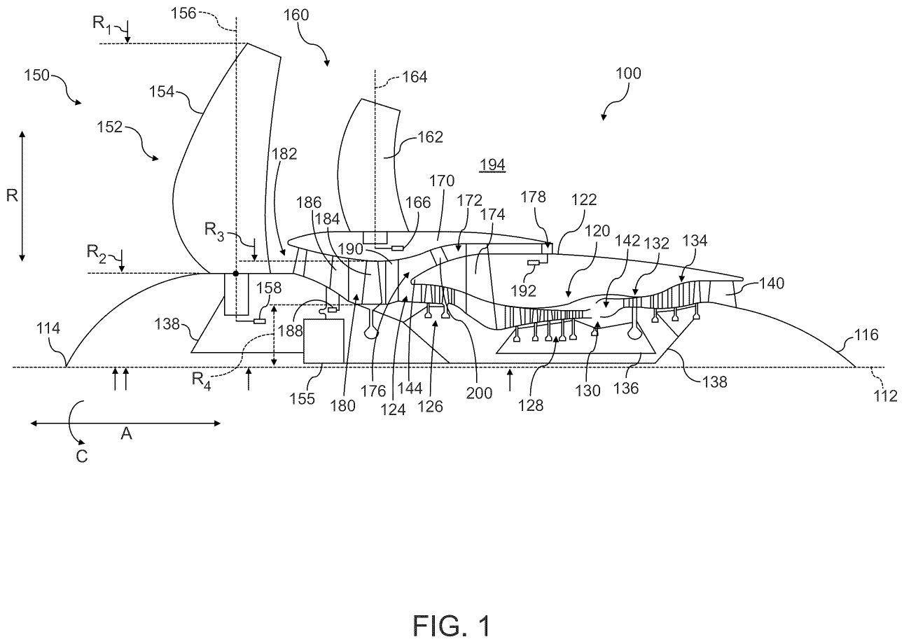

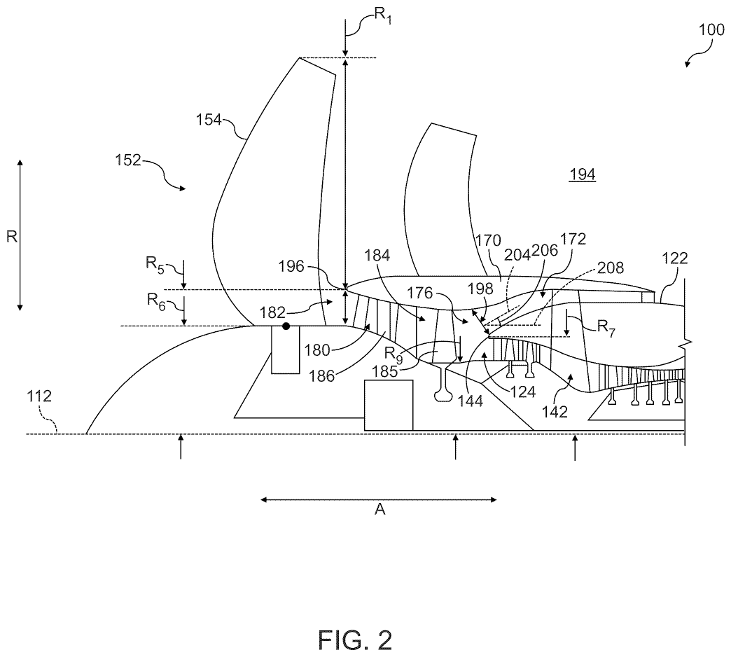

The term “bypass passage” refers generally to a passage with an airflow from a fan of the gas turbine engine that flows over an upstream-most inlet to a turbomachine of the gas turbine engine. In a ducted gas turbine engine, the bypass passage is the passage defined between an outer nacelle (surrounding the fan of the gas turbine engine) and one or more cowls inward of the outer nacelle (e.g., a fan cowl, a core cowl or both if both are present; see, e.g., FIGS. 7 through 9). In an unducted gas turbine engine, the bypass passage refers to an open sided passage (i.e., not explicitly defined by structure such as an outer nacelle) where airflow from the fan passes over an upstream-most inlet to the turbomachine (e.g., inlet 182 to inlet duct 180 in FIGS. 1 and 2), defined at least in part by a primary fan outer fan area, which refers to an area defined by an annulus representing a portion of the fan located outward of an inlet splitter at the upstream-most inlet to the turbomachine (e.g., inlet splitter 196 of the fan cowl 170 in the embodiment of FIGS. 1 and 2). An airflow through the bypass passage of a ducted or an unducted engine refers to all of the airflow from the fan that is not provided through the upstream-most inlet to the turbomachine.

The term “disk loading” refers to a power absorbed by the fan divided by the frontal or annular or swept area of the fan blades.

The term “rated speed” refers to an operating condition of an engine whereby the engine is operating in the maximum, full load operating condition that is rated by the manufacturer. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

Generally, an aeronautical gas turbine engine includes a fan to provide a desired amount of thrust without overloading the fan blades (i.e., without increasing a disk loading of the fan blades of the fan beyond a certain threshold), and therefore to maintain a desired overall propulsive efficiency for the gas turbine engine. Conventional gas turbine engine design practice has been to provide an outer nacelle surrounding the fan to provide relatively efficient thrust for the gas turbine engine. Such a configuration, sometimes referred to as a turbofan engine configuration, may generally limit a permissible size of the fan (i.e., a diameter of the fan). However, the inventors of the present disclosure have found that gas turbine engine design is now driving the diameter of the fan higher to provide as much thrust for the gas turbine engine as possible from the fan to improve an overall propulsive efficiency of the gas turbine engine.

By increasing the fan diameter, an installation of the gas turbine engine becomes more difficult. In addition, if an outer nacelle is maintained, the outer nacelle may become weight prohibitive with some larger diameter fans. Further, as the need for gas turbine engines to provide more thrust continues, the thermal demands on the gas turbine engines correspondingly increases.

The inventors of the present disclosure found that for a three stream gas turbine engine having a primary fan and a secondary fan, with the secondary fan being a ducted fan providing an airflow to a third stream of the gas turbine engine, an overall propulsive efficiency of the gas turbine engine that results from providing a high diameter fan may be maintained at a high level, while reducing the size of the primary fan. Such a configuration may maintain a desired overall propulsive efficiently for the gas turbine engine, or unexpectedly may in fact increase the overall propulsive efficiency of the gas turbine engine.

The inventors proceeded in the manner of designing a gas turbine engine with given primary fan characteristics, secondary fan characteristics, and turbomachine characteristics; checking the propulsive efficiency of the designed gas turbine engine; redesigning the gas turbine engine with varying primary fan, secondary fan, and turbomachine characteristics; rechecking the propulsive efficiency of the redesigned gas turbine engine; etc. during the design of several different types of gas turbine engines, including the gas turbine engines described below with reference to FIGS. 1 and 6 through 10. During the course of this practice of studying/evaluating various primary fan characteristics, secondary fan characteristics, and turbomachine characteristics considered feasible for best satisfying mission requirements, it was discovered that certain relationships exist between a ratio of an airflow through the bypass passage and the third stream to an airflow through a core duct (referred to hereinbelow as a thrust to power airflow ratio), as well as between a ratio of an airflow through the third steam to the airflow through the core duct (referred to hereinbelow as a core bypass ratio). In particular, the inventors of the present disclosure have found that these ratios can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

Referring now to FIG. 1, a schematic cross-sectional view of a gas turbine engine 100 is provided according to an example embodiment of the present disclosure. Particularly, FIG. 1 provides a gas turbine engine having a rotor assembly with a single stage of unducted rotor blades. In such a manner, the rotor assembly may be referred to herein as an “unducted fan,” or the entire engine 100 may be referred to as an “unducted gas turbine engine.” In addition, the engine 100 of FIG. 1 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees) (360° around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustor 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Further, each fan blade 154 defines a fan blade tip radius R₁ along the radial direction R from the longitudinal axis 112 to the tip, and a hub radius (or inner radius) R₂ along the radial direction R from the longitudinal axis 112 to the base of each fan blade 154 (i.e., from the longitudinal axis 112 to a radial location where each fan blade 154 meets a front hub of the gas turbine engine 100 at a leading edge of the respective fan blade 154). As will be appreciated, a distance from the base of each fan blade 154 to a tip of the respective fan blade 154 is referred to as a span of the respective fan blade 154. Further, the fan 152, or rather each fan blade 154 of the fan 152, defines a fan radius ratio, RqR, equal to R₂ divided by R₁. As the fan 152 is the primary fan of the engine 100, the fan radius ratio, RqR, of the fan 152 may be referred to as the primary fan radius ratio, RqR_{Prim.-Fan}.

Moreover, each fan blade 154 defines a central blade axis 156. For this embodiment, each fan blade 154 of the fan 152 is rotatable about their respective central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1; see fan blades 185 labeled in FIG. 2) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween. Further, each fan blade of the ducted fan 184 defines a fan blade tip radius R₃ along the radial direction R from the longitudinal axis 112 to the tip, and a hub radius (or inner radius) R₄ along the radial direction R from the longitudinal axis 112 to the base of the respective fan blades of the ducted fan 184 (i.e., a location where the respective fan blades of the ducted fan 184 meet an inner flowpath liner at a leading edge of the respective fan blades of the ducted fan 184). As will be appreciated, a distance from the base of each fan blade of the ducted fan 184 to a tip of the respective fan blade is referred to as a span of the respective fan blade. Further, the ducted fan 184, or rather each fan blade of the ducted fan 184, defines a fan radius ratio, RqR, equal to R₄ divided by R₃. As the ducted fan 184 is the secondary fan of the engine 100, the fan radius ratio, RqR, of the ducted fan 184 may be referred to as the secondary fan radius ratio, RqR_{Sec.-Fan}.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. The inlet duct 180 is wider than the core duct 142 along the radial direction R. The inlet duct 180 is also wider than the fan duct 172 along the radial direction R. The secondary fan 184 is positioned at least partially in the inlet duct 180.

Notably, for the embodiment depicted, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 200 may be positioned in thermal communication with the fan duct 172. For example, one or more heat exchangers 200 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 200 may be an annular heat exchanger extending substantially 360 degrees in the fan duct 172 (e.g., at least 300 degrees, such as at least 330 degrees). In such a manner, the heat exchanger 200 may effectively utilize the air passing through the fan duct 172 to cool one or more systems of the engine 100 (e.g., lubrication oil systems, compressor bleed air, electrical components, etc.). The heat exchanger 200 uses the air passing through duct 172 as a heat sink and correspondingly increases the temperature of the air downstream of the heat exchanger 200 and exiting the fan exhaust nozzle 178.

Referring now to FIG. 2, a close-up, simplified, schematic view of the gas turbine engine 100 of FIG. 1 is provided. The gas turbine engine 100, as noted above includes a primary fan, or rather fan 152 having fan blades 154, and a secondary fan, or rather ducted fan 184 having fan blades 185. Airflow from the fan 152 is split between a bypass region 194 (as defined below) and the inlet duct 180 by an inlet splitter 196. Airflow from the ducted fan 184 is split between the fan duct 172 and the core duct 142 by the leading edge 144 (sometimes also referred to as a fan duct splitter).

The exemplary gas turbine engine 100 depicted in FIG. 2 further defines a primary fan outer fan area, A_{P_Out}, a primary fan inner fan area, A_{P_In}, a secondary fan outer fan area, A_{S_Out}, and a secondary fan inner fan area, A_{S_In}.

The primary fan outer fan area, A_{P_Out}, refers to an area defined by an annulus representing a portion of the fan 152 located outward of the inlet splitter 196 of the fan cowl 170. In particular, the gas turbine engine 100 further defines a fan cowl splitter radius, R₅. The fan cowl splitter radius, R₅, is defined along the radial direction R from the longitudinal axis 112 to the inlet splitter 196. The primary fan outer fan area, A_{P_Out}, refers to an area defined by the formula:

$$π {R}_{1}^{2} - π {R}_{5}^{2} .$$

The primary fan inner fan area, A_{P_In}, refers to an area defined by an annulus representing a portion of the fan 152 located inward of the inlet splitter 196 of the fan cowl 170. In particular, the gas turbine engine 100 further defines an engine inlet inner radius, R₆. The engine inlet inner radius, R₆, is defined along the radial direction R from the longitudinal axis 112 to an inner casing defining the engine inlet 182 directly inward along the radial direction R from the inlet splitter 196. The primary fan inner fan area, A_{P_In}, refers to an area defined by the formula:

$$π {R}_{5}^{2} - π {R}_{6}^{2} .$$

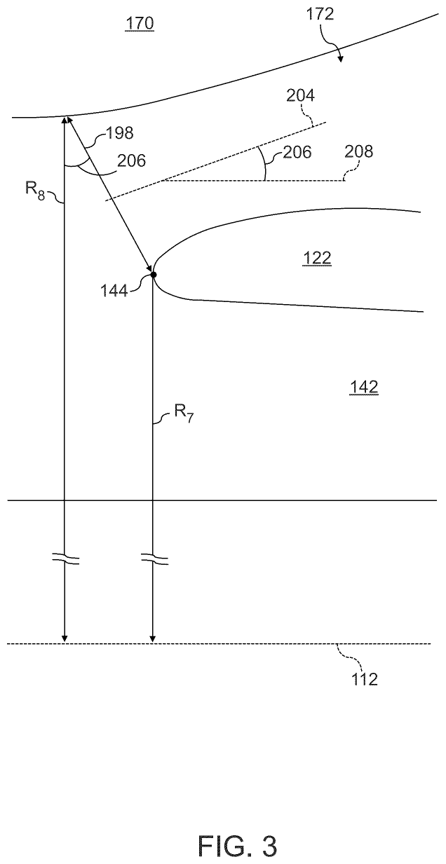

The secondary fan outer fan area, A_{S_Out}, refers to an area representing a portion of an airflow from the ducted fan 184 that is provided to the fan duct 172. In particular, the leading edge 144 defines a leading edge radius, R₇, and the gas turbine engine 100 defines an effective fan duct inlet outer radius, R₈ (see FIG. 3). The leading edge radius, R₇, is defined along the radial direction R from the longitudinal axis 112 to the leading edge 144.

Referring briefly to FIG. 3, providing a close-up view of an area surrounding the leading edge 144, the fan duct 172 defines a cross-wise height 198 measured from the leading edge 144 to the fan cowl 170 in a direction perpendicular to a mean flow direction 204 of an airflow through a forward 10% of the fan duct 172. An angle 206 is defined by the mean flow direction 204 relative to a reference line 208 extending parallel to the longitudinal axis 112. The angle 206 is referred to as 0. In certain embodiments, the angle 206 may be between 5 degrees and 80 degrees, such as between 10 degrees and 60 degrees (an increased angle is a counterclockwise rotation in FIG. 3). The effective fan duct inlet outer radius, R₈, is defined along the radial direction R from the longitudinal axis 112 to where the cross-wise height 198 meets the fan cowl 170. The secondary fan outer fan area, A_{S_Out}, refers to an area defined by the formula:

$$\frac{π ( {R}_{8}^{2} - {R}_{7}^{2} )}{cos ( θ )} .$$

Referring back to FIG. 2, the secondary fan inner fan area, A_{S_In}, refers to an area defined by an annulus representing a portion of the ducted fan 184 located inward of the leading edge 144 of the core cowl 122. In particular, the gas turbine engine 100 further defines a core inlet inner radius, R₉. The core inlet inner radius, R₉, is defined along the radial direction R from the longitudinal axis 112 to an inner casing defining the core inlet 124 directly inward along the radial direction R from the leading edge 144. The secondary fan inner fan area, A_{S_In}, refers to an area defined by the formula:

$$π {R}_{7}^{2} - π {R}_{9}^{2} .$$

The primary fan outer fan area, A_{P_Out}, the primary fan inner fan area, A_{P_In}, the secondary fan outer fan area, A_{S_Out}, and the secondary fan inner fan area, A_{S_In}, may be used in defining various airflow ratios for the engine 100. In particular, it will be appreciated that the exemplary engine 100 of FIGS. 1 through 3 further defines a thrust to power airflow ratio and a core bypass ratio, which as discussed herein are used to define an engine in accordance with the present disclosure. The thrust to power airflow ratio is a ratio of an airflow through the bypass passage of the engine 100 and through the fan duct 172 to an airflow through the core duct 142. The bypass passage (not separately labeled) is located within the bypass region 194 and refers to a passage where airflow from the fan 152 passes over the inlet duct 180. Further, the core bypass ratio is a ratio of an airflow through the fan duct 172 to the airflow through the core duct 142. These ratios are calculated while the engine 100 is operating at a rated speed during standard day operating conditions, and the amounts of airflow used to calculate these ratios are each expressed as a mass flowrate in the same units (mass per unit time).

More specifically, the amount of airflow through the engine's bypass passage can be determined using a fan pressure ratio for the fan 152, a rotational speed of the fan 152, or both while the engine is operating at the rated speed during standard day operating conditions, and the primary fan outer fan area, A_{P_Out}. The amount of airflow through the inlet duct 180 can be determined using a fan pressure ratio for the fan 152, a rotational speed of the fan 152, or both while operating at a rated speed during standard day operating conditions, and the primary fan inner fan area, A_{P_In}. The amount of airflow through the fan duct 172 and the amount of airflow through the core duct 142 can be determined based on the amount of airflow through the inlet duct 180 while the engine is operating at the rated speed during standard day operating conditions; a fan pressure ratio, a rotational speed, or both of the ducted fan 184 while the engine is operating at the rated speed during standard day operating conditions; and the secondary fan outer fan area, A_{S_Out}, and the secondary fan inner fan area, A_{S_In}.

As alluded to earlier, the inventors discovered, unexpectedly during the course of gas turbine engine design—i.e., designing gas turbine engines (e.g., both ducted and unducted gas turbine engines and turboprop engines) having a variety of different primary fan and secondary fan characteristics—and evaluating an overall propulsive efficiency, significant relationships exist in a ratio of an airflow through a bypass passage and through a third stream to an airflow through a core duct (referred to herein as a thrust to power airflow ratio), as well as in a ratio of an airflow through the third steam to the airflow through the core duct (referred to herein as a core bypass ratio). These relationships can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

As will be appreciated, it may generally be desirable to increase a fan diameter in order to provide a higher thrust to power airflow ratio, which typically correlates to a higher overall propulsive efficiency. However, increasing the fan diameter too much may actually result in a decrease in propulsive efficiency at higher speeds due to a drag from the fan blades. Further, increasing the fan diameter too much may also create prohibitively heavy fan blades, creating installation problems due to the resulting forces on the supporting structure (e.g., frames, pylons, etc.), exacerbated by a need to space the engine having such fan blades further from a mounting location on the aircraft to allow the engine to fit, e.g., under/over the wing, adjacent to the fuselage, etc.

Similarly, it may generally be desirable to increase an airflow through the fan duct relative to the core duct in order to provide a higher core bypass ratio, as such may also generally correlate to a higher overall propulsive efficiency. Notably, however, the higher the core bypass ratio, the less airflow provided to the core of the gas turbine engine. For a given amount of power needed to drive, e.g., a primary fan and a secondary fan of the gas turbine engine, if less airflow is provided, either a maximum temperature of the core needs to be increased or a size of the primary fan or secondary fan needs to be decreased. Such a result can lead to either premature wear of the core or a reduction in propulsive efficiency of the gas turbine engine.

As noted above, the inventors of the present disclosure discovered bounding the relationships defined by the thrust to power airflow ratio and core bypass ratio can result in a gas turbine engine maintaining or even improving upon a desired propulsive efficiency, while also taking into account the gas turbine engine's packaging concerns and weight concerns, and also providing desired thermal management capabilities. The relationship discovered, infra, can identify an improved engine configuration suited for a particular mission requirement, one that takes into account installation, packaging and loading, thermal sink needs and other factors influencing the optimal choice for an engine configuration.

In addition to yielding an improved gas turbine engine, as explained in detail above, utilizing this relationship, the inventors found that the number of suitable or feasible gas turbine engine designs incorporating a primary fan and a secondary fan, and defining a third stream, capable of meeting both the propulsive efficiency requirements and packaging, weight, and thermal sink requirements could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationships providing for the improved gas turbine engine, discovered by the inventors, are expressed as:

$$TPAR = ( {A}_{B} + {A}_{3 S} ) / {A}_{C} \qquad ( 1 )$$

$$CBR = {A}_{3 S} / {A}_{C} \qquad ( 2 )$$

where TPAR is a thrust to power airflow ratio, CBR is a core bypass ratio, A_{B} is an airflow through a bypass passage of the gas turbine engine while the engine is operated at a rated speed during standard day operating conditions, A_{3S} is an airflow through a third stream of the gas turbine engine while the engine is operated at the rated speed during standard day operating conditions, and A_{C} is an airflow through a core of the gas turbine engine while the engine is operated at the rated speed during standard day operating conditions. The airflow through the core of the gas turbine engine may refer to an airflow through an upstream end of the core (e.g., an airflow through a first stage of a high pressure compressor of the core). A_{B}, A_{3S}, and A_{C} are each expressed as mass flowrate, with the same units as one another.

Values for various parameters of the influencing characteristics of an engine defined by Expressions (1) and (2) are set forth below in TABLE 1:

TABLE 1

| | | Ranges appropriate for using |
|---|---|---|
| Symbol | Description | Expression (1) |
| R₁/R₃ | Tip radius ratio | 1.35 to 10, such as 2 to 7, such |
| | | as 3 to 5, such as at least 3.5, |
| | | such as at least 3.7, such as at |
| | | least 4, such as up to 10, such |
| | | as up to 7 |
| RqR_{Sec.-Fan} | Secondary fan | 0.2 to 0.9, such as 0.2 to 0.7, |
| | radius ratio | such as 0.57 to 0.67 |
| RqR_{Prim.-Fan} | Primary fan radius | 0.2 to 0.4, such as 0.25 to 0.35 |
| | ratio | |
| TPAR | Thrust to power | 3.5 to 100, such as 4 to 75 |
| | airflow ratio | (see also, TABLE 2, below) |
| CBR | Core Bypass Ratio | 0.1 to 10, such as 0.3 to 5 |
| | | (see also, TABLE 2, below) |

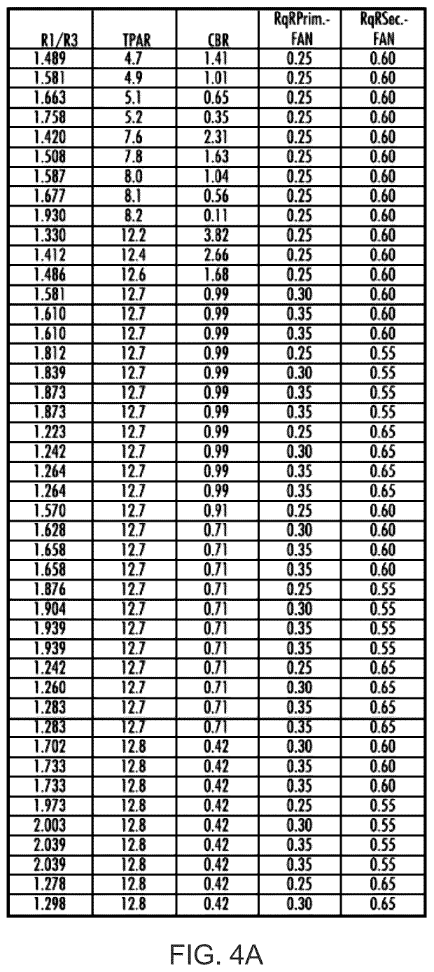

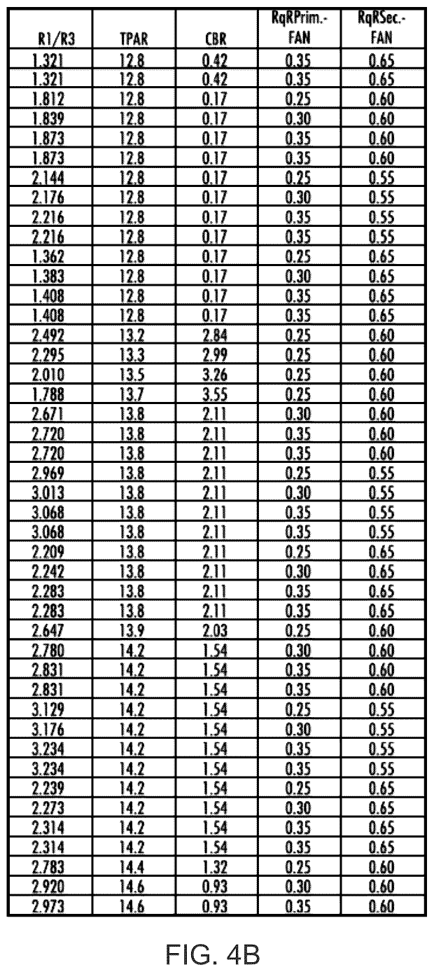

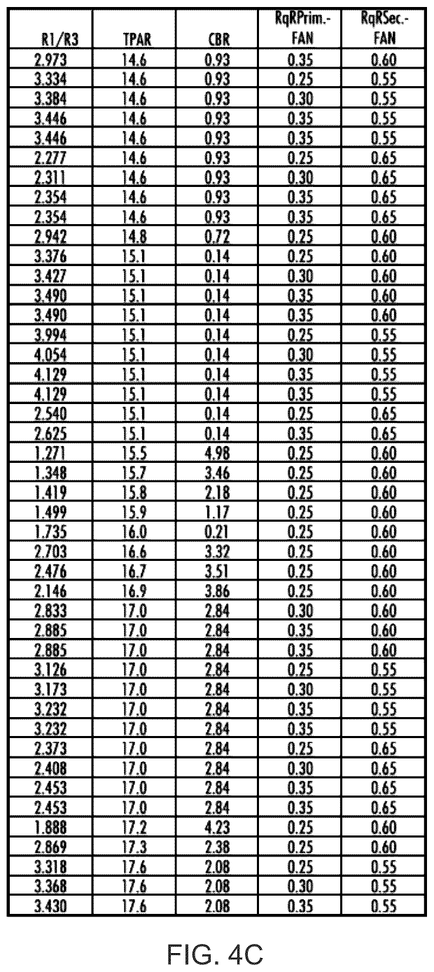

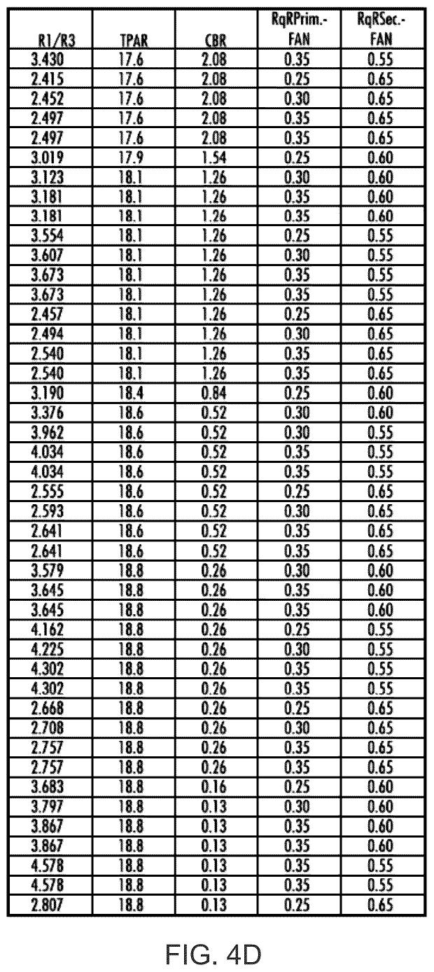

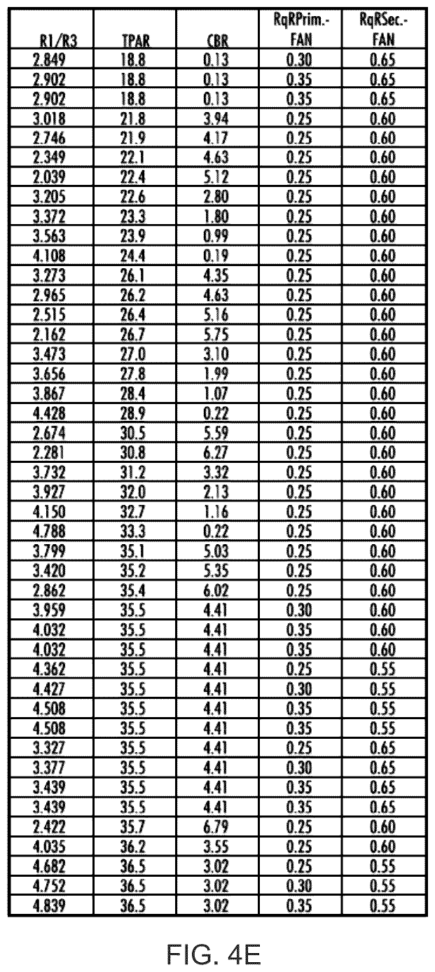

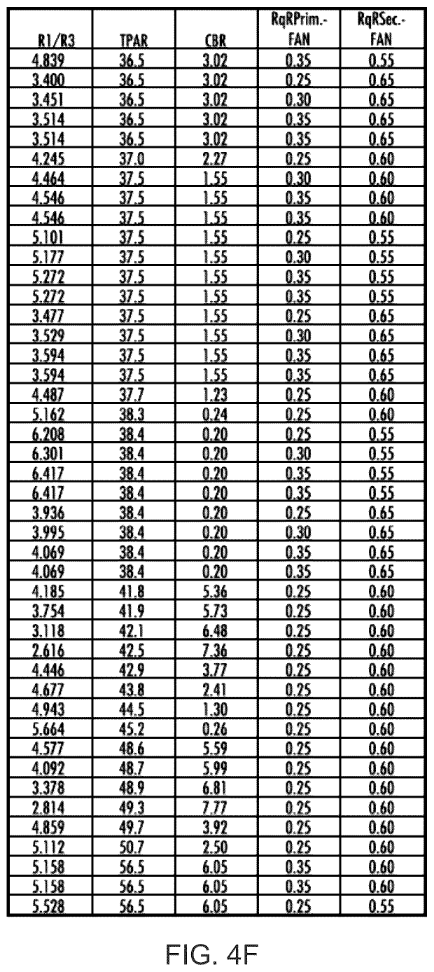

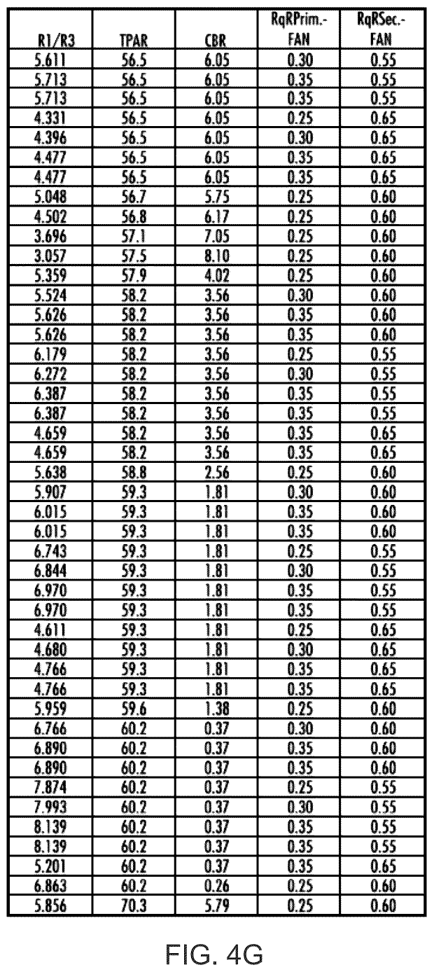

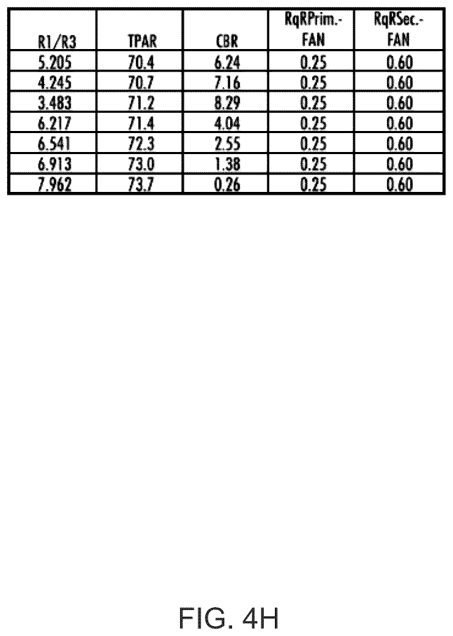

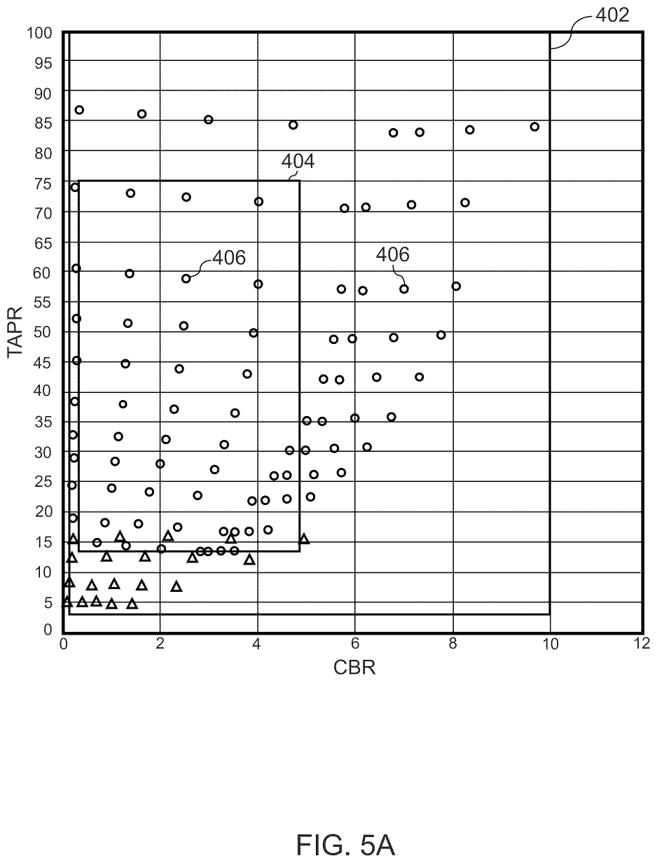

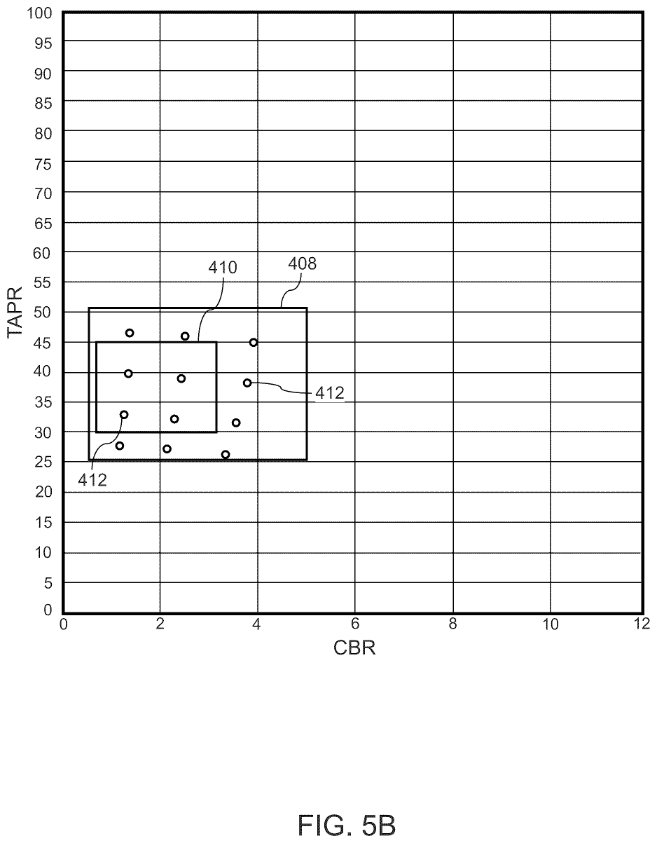

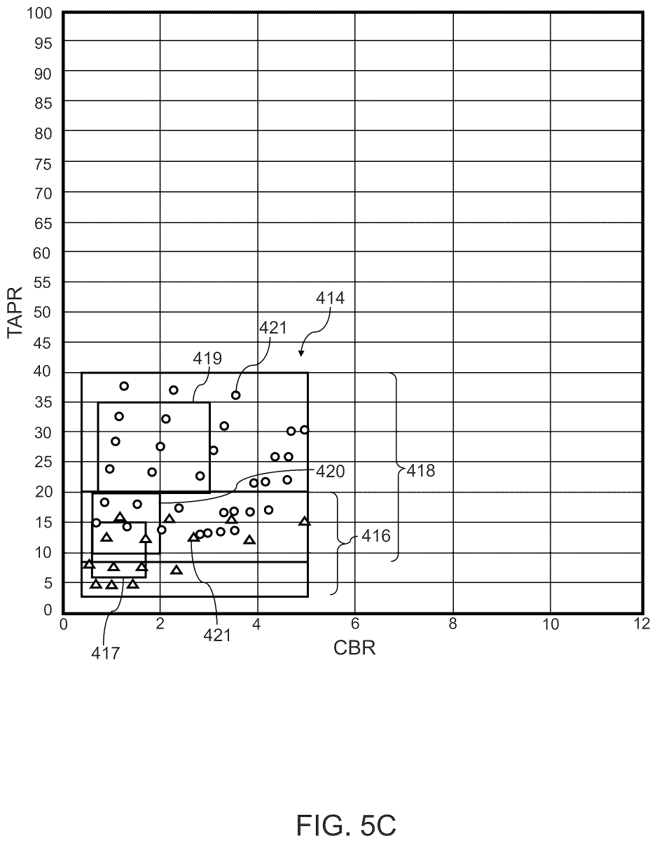

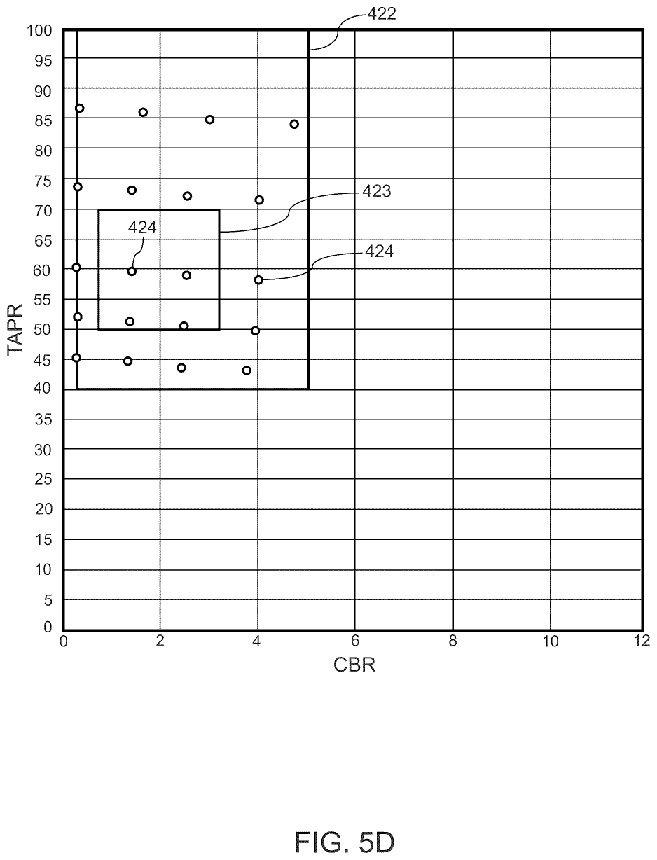

Referring now to FIGS. 4A through 4H and 5A through 5D, the relationships between the various parameters of Expressions (1) and (2) of exemplary gas turbine engines are illustrated in accordance with one or more exemplary embodiments of the present disclosure. In particular, FIGS. 4A through 4H provide a table including numerical values corresponding to several of the plotted gas turbine engines in FIGS. 5A through 5D. FIGS. 5A through 5D are plots of gas turbine engines in accordance with one or more exemplary embodiments of the present disclosure, showing the TPAR (Y-Axis) and the CBR (X-axis). FIGS. 5A through 5D highlight preferred subranges, including subranges for unducted engines, ducted engines, and turboprop engines, as discussed hereinbelow.

Referring particularly to FIG. 5A, a first range 402 and a second range 404 are provided, and exemplary embodiments 406 are plotted. The exemplary embodiments 406 include a variety of gas turbine engine types in accordance with aspects of the present disclosure, including unducted gas turbine engines, ducted gas turbine engines (turbofan engines), and turboprop engines. The first range 402 corresponds to a TPAR between 3.5 and 100 and a CBR between 0.1 and 10. The first range 402 captures the benefits of the present disclosure across the variety of engine types. The second range 404 corresponds to a TPAR between 14 and 75 and a CBR between 0.3 and 5. The second range 404 may provide more desirable TPAR and CBR relationships across the variety of engine types to achieve propulsive efficiency, while still providing packaging and weight benefits, thermal benefits, etc.

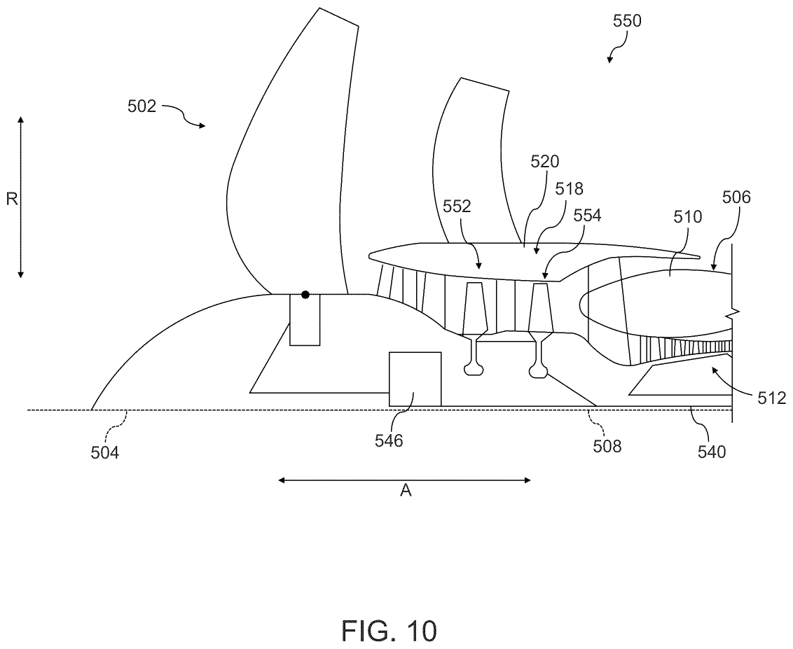

Referring particularly to FIG. 5B, a third range 408 and a fourth range 410 are provided, and exemplary embodiments 412 are plotted. The exemplary embodiments 412 include a variety of unducted gas turbine engines in accordance with aspects of the present disclosure. In particular, the exemplary embodiments 412 include a variety of gas turbine engines having an unducted primary fan, similar to the exemplary embodiments described herein with reference to FIGS. 1 and 10. The third range 408 corresponds to a TPAR between 30 and 56 and a CBR between 0.3 and 5. The third range 408 captures the benefits of the present disclosure for unducted gas turbine engines. The fourth range 410 corresponds to a TPAR between 35 and 50 and a CBR between 0.5 and 3. The fourth range 410 may provide more desirable TPAR and CBR relationships for the unducted gas turbine engines to achieve propulsive efficiency, while still providing packaging and weight benefits, thermal benefits, etc.

As will be appreciated, the unducted gas turbine engines may have, on the whole, a higher TPAR as compared to the ducted gas turbine engines (see FIG. 5C), enabled by a lack of an outer nacelle or other casing surrounding a primary fan. The range of CBR values in the fourth range 410 isn't as large as the range of CBR values in the third range 408, as in the embodiments with a higher TPAR, the CBR needs to be lower to provide a necessary amount of airflow to a core of the engine without exceeding temperature thresholds or requiring an undesired reduction in a size of the primary fan.

The inventors of the present disclosure have found that the TPAR values and CBR values in the third and fourth ranges 408, 410 shown may provide a desirable propulsive benefit, while still enabling operation of the core in a reasonable manner, and balancing installation and thermal load considerations.

Referring particularly to FIG. 5C, a fifth range 414, a sixth range 416, a seventh range 417, an eighth range 418, a ninth range 419, and a tenth range 420 are provided, and exemplary embodiments 421 are plotted. The exemplary embodiments 421 include a variety of ducted gas turbine engines in accordance with aspects of the present disclosure. In particular, the exemplary embodiments 421 include a variety of gas turbine engines having a ducted primary fan, similar to the exemplary embodiments described herein with reference to FIGS. 7 through 9. The fifth range 414 corresponds to a TPAR between 3.5 and 40 and a CBR between 0.3 and 5. The fifth range 414 captures the benefits of the present disclosure for ducted gas turbine engines.

The sixth range 416 corresponds to a TPAR between 3.5 and 20 and a CBR between 0.2 and 5. The sixth range 416 captures the benefits of the present disclosure for ducted gas turbine engines in a direct drive configuration (see, e.g., FIG. 7). As will be appreciated, with a ducted, direct drive gas turbine engine a primary fan may be smaller, limiting a TPAR. The seventh range 417, which also corresponds to ducted gas turbine engines in a direct drive configuration, corresponds to a TPAR between 6 and 15 and a CBR between 0.3 and 1.8, and may represent a more preferrable range.

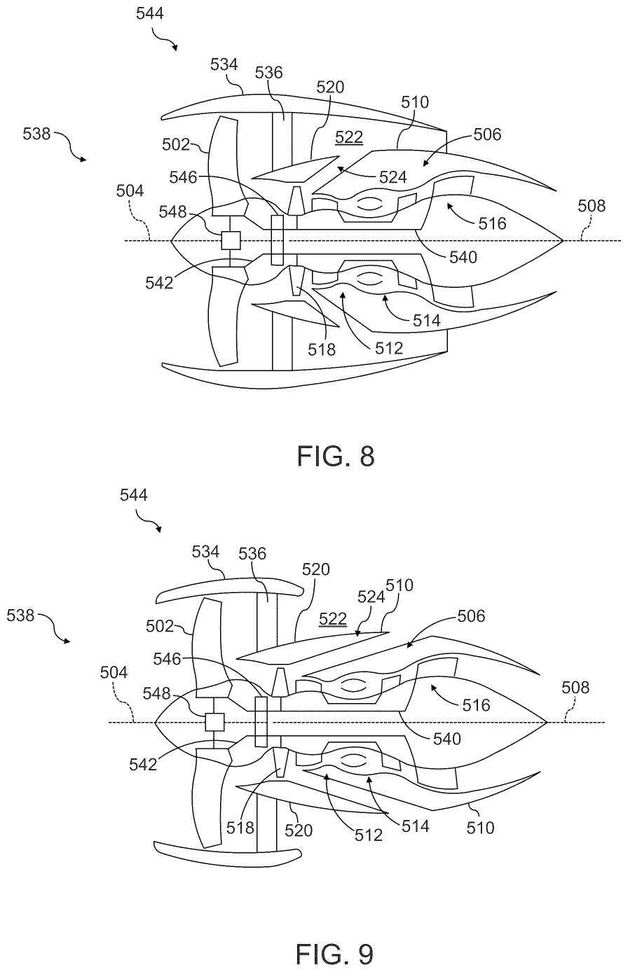

The eighth range 418 corresponds to a TPAR between 8 and 40 and a CBR between 0.2 and 5. The eighth range 418 captures the benefits of the present disclosure for ducted gas turbine engines in a geared configuration (see, e.g., FIGS. 8 and 9). As will be appreciated, with a ducted, geared gas turbine engine a primary fan may be larger as compared to a ducted, direct drive gas turbine engine, allowing for a larger TPAR. TPAR is, in turn limited by an allowable nacelle drag and fan operability.

The ninth range 419 corresponds to ducted gas turbine engines in a geared configuration having a variable pitch primary fan (see FIGS. 8 and 9) and the tenth range 420 corresponds to ducted gas turbine engines in a geared configuration having a fixed pitch primary fan. Inclusion of a variable pitch primary fan may allow for a larger fan, but may also necessitate higher heat rejection abilities for the gas turbine engine, which may, in turn increase a CBR. The ninth range 419 corresponds to a TPAR between 20 and 35 and a CBR between 0.5 and 3, and the tenth range 420 corresponds to a TPAR between 10 and 20 and a CBR between 0.3 and 2. It will be appreciated that in other exemplary aspects, a gas turbine engine of the present disclosure in a ducted, geared, variable pitch configuration may have TPAR between 15 and 40 and a CBR between 0.3 and 5, and a gas turbine engine in a ducted, geared, fixed pitch configuration may have TPAR between 8 and 25 and a CBR between 0.3 and 5.

As will be appreciated, the ducted gas turbine engines may have, on the whole, a lower TPAR than the unducted gas turbine engines as a result of an outer nacelle surrounding a primary fan (the outer nacelle becoming prohibitively heavy with higher diameter primary fans). Further, it will be appreciated that the TPAR values for geared engines may be higher than the TPAR values for direct drive engines, as inclusion of the gearbox allows the primary fan to rotate more slowly than the driving turbine, enabling a comparatively larger primary fan without overloading the primary fan or generating shock losses at a tip of the primary fan. The range of CBR values may generally be relatively high given the relatively low TPAR values (since a relatively high amount of airflow is provided to a secondary fan through an engine inlet when the TPAR values are low), as a necessary amount of airflow to a core of the ducted gas turbine engine may still be provided with a relatively high CBR without exceeding temperature thresholds or requiring a reduction in a size of the primary fan.

The inventors of the present disclosure have found that the TPAR values and CBR values in the fifth, sixth, seventh, eighth, ninth, and tenth ranges 414, 416, 417, 418, 419, 420 shown may provide a desirable propulsive benefit, while still enabling operation of the core in a reasonable manner, and balancing installation and thermal load considerations.

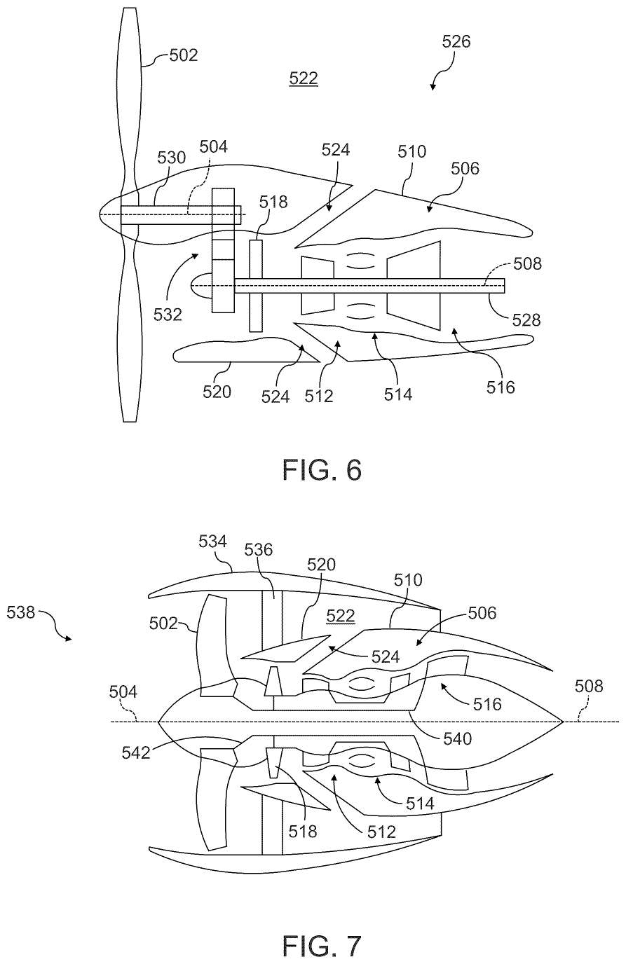

Referring particularly to FIG. 5D, an eleventh range 422 and a twelfth range 423 are provided, and exemplary embodiments 424 are plotted. The exemplary embodiments 424 include a variety of turboprop gas turbine engines in accordance with aspects of the present disclosure. In particular, the exemplary embodiments 424 include a variety of turboprop gas turbine engine similar to the exemplary embodiment described herein with reference to FIG. 6. The eleventh range 422 corresponds to a TPAR between 40 and 100 and a CBR between 0.3 and 5. The eleventh range 422 captures the benefits of the present disclosure for turboprop gas turbine engines. The twelfth range 423 corresponds to a TPAR between 50 and 70 and a CBR between 0.5 and 3, and may represent a more preferrable range.

As will be appreciated, the turboprop gas turbine engines may have, on the whole, higher TPAR values than turbofan engines, enabled by the lack of an outer nacelle or other casing surrounding a primary fan and a relatively slow operational speed of the primary fan and aircraft incorporating the turboprop gas turbine engine. The range of CBR values in the eleventh range 422 and the twelfth range 423 may be relatively small, as less air may be provided through a third stream with such a high TPAR without compromising operation of a core of the gas turbine engine.

The inventors of the present disclosure have found that the TPAR values and CBR values in the eleventh range 422 and twelfth range 423 shown may provide a desirable propulsive benefit, while still enabling operation of the core in a reasonable manner, and balancing installation and thermal load considerations.

TABLE 2, below provides a summary of TPAR values and CBR values for various gas turbine engines in accordance with one or more exemplary aspects of the present disclosure.

TABLE 2

| Engine Type | TPAR Value | CBR Value |
|---|---|---|
| All Aeronautical Gas Turbine Engines | 3.5 to 100 | 0.1 to 10 |
| (“GTE”) | | |
| All Aeronautical GTE | 4 to 75 | 0.3 to 5 |
| Open Rotor GTE | 30 to 60 | 0.3 to 5 |
| Open Rotor GTE | 35 to 50 | 0.5 to 3 |
| Ducted Gas GTE | 3.5 to 40 | 0.2 to 5 |
| Ducted, Geared GTE | 8 to 40 | 0.2 to 5 |
| Ducted, Geared, Variable Pitch GTE | 15 to 40 | 0.3 to 5 |
| Ducted, Geared, Variable Pitch GTE | 20 to 35 | 0.5 to 3 |
| Ducted, Geared, Fixed-Pitch GTE | 8 to 25 | 0.2 to 5 |
| Ducted, Geared, Fixed-Pitch GTE | 10 to 20 | 0.3 to 2 |
| Ducted, Direct Drive GTE | 3.5 to 20 | 0.2 to 5 |
| Ducted, Direct Drive GTE (lower flight | 6 to 20 | 0.2 to 5 |
| speed) | | |
| Ducted, Direct Drive GTE (lower flight | 8 to 15 | 0.3 to 1.8 |
| speed) | | |
| Ducted, Direct Drive GTE (higher flight | 3.5 to 10 | 0.2 to 2 |
| speed) | | |
| Ducted, Direct Drive GTE (higher flight | 3.5 to 6 | 0.3 to 1.5 |
| speed) | | |
| Turboprop GTE | 40 to 100 | 0.3 to 5 |
| Turboprop GTE | 50 to 70 | 0.5 to 3 |

For the purposes of Table 2, the term “Ducted” refers to inclusion of an outer nacelle around a primary fan (see, e.g., FIGS. 7 to 9); “Open Rotor” refers to inclusion of an unducted primary fan (see, e.g., FIGS. 1, 10); “Geared” refers to inclusion of a reduction gearbox between the primary fan and a driving turbine (see, e.g., FIGS. 8 to 10); “Direct Drive” refers to exclusion of a reduction gearbox between the primary fan and a driving turbine (see, e.g., FIG. 7); “Variable Pitch” refers to inclusion of a pitch change mechanism for changing a pitch of fan blades on a primary fan (see, e.g., FIGS. 1, 8, 9); “Fixed Pitch” refers to exclusion of a pitch change mechanism for changing a pitch of fan blades on a primary fan (see, e.g., FIGS. 6 to 7); “lower flight speed” refers to an engine designed to operate at a flight speed less than 0.85 Mach; and “higher flight speed” refers to an engine designed to operate at a flight speed higher than 0.85 Mach.

It will be appreciated that although the discussion above is generally relating to the open rotor engine 100 described above with reference to FIGS. 1 and 2, in various embodiments of the present disclosure, the relationships outlined above with respect to, e.g., Expressions (1) and (2) may be applied to any other suitable engine architecture. For example, reference will now be made to FIGS. 6 through 12, each depicting schematically an engine architecture associated with the present disclosure.

Each of the gas turbine engines of FIGS. 6 through 9 generally include a rotor 502 rotatable about a rotor axis 504 and a turbomachine 506 rotatable about a longitudinal axis 508. The rotor 502 corresponds to the “primary fan” described herein. The turbomachine 506 is surrounded at least in part by a core cowl 510 and includes a compressor section 512, a combustion section 514, and a turbine section 516 in serial flow order. In addition to the rotor 502, the gas turbine engines of FIGS. 7 through 9 each also include a ducted mid-fan or secondary fan 518. The gas turbine engines each include a fan cowl 520 surrounding the secondary fan 518.

Referring still to the gas turbine engines of FIGS. 6 through 9, the gas turbine engines each also define a bypass passage 522 downstream of the respective rotor 502 and over the respective fan cowl 520 and core cowl 510, and further define a third stream 524 extending from a location downstream of the respective secondary fan 518 to the respective bypass passage 522 (at least in the embodiments depicted; in other embodiments, the third stream 524 may instead extend to a location downstream of the bypass passage 522).

Referring particularly to FIG. 6, the exemplary gas turbine engine depicted is configured as a turboprop engine 526. In such a manner, the rotor 502 (or primary fan) is configured as a propeller, defining a relatively large diameter. Further, the turboprop engine 526 includes an engine shaft 528 driven by the turbomachine 506, a fan shaft 530 rotatable with the rotor 502, and a gearbox 532 mechanically coupling the engine shaft 528 with the fan shaft 530. The gearbox 532 is an offset gearbox such that the rotor axis 504 is radially offset from the longitudinal axis 508 of the turboprop engine 526.

Notably, in other embodiments of the present disclosure, a turboprop engine may be provided with a reverse flow combustor.

Referring to FIGS. 7 through 9, the gas turbine engines are each configured as turbofan engines, and more specifically as ducted turbofan engines. In such a manner, the gas turbine engines each include an outer nacelle 534 surrounding the rotor 502, and the rotor 502 (or primary fan) of each is therefore configured as a ducted fan. Further, each of the gas turbine engines includes outlet guide vanes 536 extending through the bypass passage 522 to the outer nacelle 534 from the fan cowl 520, the core cowl 510, or both.

More specifically, still, the gas turbine engine of FIG. 7 is configured as a direct drive, ducted, turbofan engine 538. In particular, the direct drive, ducted, turbofan engine 538 includes an engine shaft 540 driven by the turbine section 516 and a fan shaft 542 rotatable with the rotor 502. The fan shaft 542 is configured to rotate directly with (i.e., at the same speed as) the engine shaft 540.

By contrast, the gas turbine engine of FIG. 8 is configured as a geared, ducted, turbofan engine 544. In particular, the geared, ducted, turbofan engine 544 includes the engine shaft 540 driven by the turbine section 516 and the fan shaft 542 rotatable with the rotor 502. However, the exemplary geared, ducted, turbofan engine 544 further includes a gearbox 546 mechanically coupling the engine shaft 540 to the fan shaft 542. The gearbox 546 allows the rotor 502 to rotate at a slower speed than the engine shaft 540, and thus at a slower speed than the secondary fan 518.

Notably, the exemplary geared, ducted, turbofan engine 544 of FIG. 8 further includes a pitch change mechanism 548 operable with the rotor 502 to change a pitch of the rotor blades of the rotor 502. Such may allow for an increased efficiency of the gas turbine engine.

Further, the exemplary gas turbine engine of FIG. 9 is again configured as a direct drive, ducted, turbofan engine 538. However, by contrast to the embodiment of FIG. 8 where a fan duct outlet defined by the fan duct is upstream of a bypass passage outlet defined by the bypass passage, in the embodiment of FIG. 9, the fan duct outlet defined by the fan duct is downstream of the bypass passage outlet defined by the bypass passage.

Moreover, in other exemplary embodiments, other suitable gas turbine engines may be provided. For example, referring now to FIG. 10, a gas turbine engine in accordance with yet another exemplary embodiment of the present disclosure is provided. The exemplary gas turbine engine of FIG. 10 may be configured in a similar manner as the exemplary gas turbine engines described above with reference to FIGS. 7 and 8.

For example, the exemplary gas turbine engine of FIG. 10 includes a rotor 502 rotatable about a rotor axis 504 and a turbomachine 506 rotatable about a longitudinal axis 508. The rotor axis 504 and the longitudinal axis 508 are aligned in the embodiment of FIG. 10. The rotor 502 corresponds to the “primary fan” described herein. The turbomachine 506 is surrounded at least in part by a core cowl 510 and includes a compressor section 512 (and, not shown, a combustion section and a turbine section in serial flow order with the compressor section 512). In addition to the rotor 502, the gas turbine engine also includes a ducted mid-fan or secondary fan 518 and a fan cowl 520 surrounding the secondary fan 518.

However, for the embodiment of FIG. 10, the gas turbine engine is configured as an unducted gas turbine engine 550 (see, e.g., FIG. 1), and the secondary fan 518 is not configured as a single stage fan (see fan 184 of FIG. 1). Instead, for the embodiment of FIG. 10, the secondary fan 518 is configured as a multi-stage secondary fan, and more specifically still as a two-stage secondary fan having a total of two stages of rotating compressor rotor blades, and more specifically having a first stage 552 of secondary fan rotor blades and a second stage 554 of secondary fan rotor blades. Notably, with such a configuration, the turbomachine 506 does not include a separate low pressure compressor.

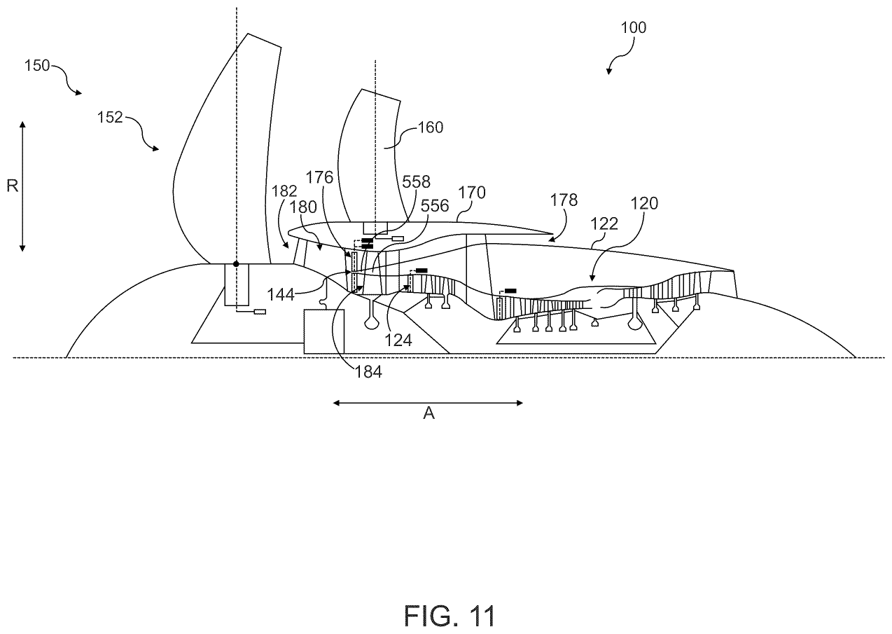

Additionally, in still other exemplary embodiments, the gas turbine engine may have other configurations. For example, referring now to FIG. 11, a gas turbine engine in accordance with yet another exemplary embodiment of the present disclosure is provided. The exemplary gas turbine engine of FIG. 11 may be configured in a similar manner as the exemplary gas turbine engines described above with reference to, e.g., FIGS. 1 through 3.

For example, the exemplary gas turbine engine of FIG. 11 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

The engine 100 also defines an inlet duct 180. The inlet duct 180 extends between an engine inlet 182 and a core inlet 124. The engine inlet 182 is defined generally at the forward end of the fan cowl 170 and is positioned between a fan 152 of the fan section 150 and a fan guide vane array 160 along the axial direction A. The engine 100 further includes a ducted fan 184 with a plurality of fan blades located at least partially in the inlet duct 180.

However, for the embodiment of FIG. 11, the core cowl 122 carries forward to an aft edge of the fan blades of the ducted fan 184 and the fan blades themselves include an integral splitter 556. This may be termed a blade-on-blade configuration where inner and outer blades are effectively superimposed upon one another and may be unitarily formed or otherwise fabricated to achieve the split between streams.

The core cowl 122 further includes a section 558 extending forward past the fan blades of the ducted fan 184, such that the leading edge 144 is located forward of the fan blades of the ducted fan 184. With such an arrangement, the fan duct inlet 176 is also located forward of the fan blades of the ducted fan 184, and an outer portion of the fan blades along the radial direction R is positioned within the fan duct 172. With this configuration, a secondary fan outer fan area, A_{S_Out}, may be calculated at the fan duct inlet 176 in the same manner discussed above with reference to, e.g., FIGS. 2 and 3.

Further, with such a configuration, the secondary fan inner fan area, A_{S_In}, still refers to an area defined by an annulus representing a portion of the ducted fan 184 located inward of the leading edge 144 of the core cowl 122. However, a calculation of the secondary fan inner fan area, A_{S_In}, is based on a leading edge radius, R₇, of the leading edge 144 and an inner fan duct radius, defined along the radial direction R, directly inward along the radial direction R from the leading edge 144 (and not a core inlet inner radius at the core inlet 124).

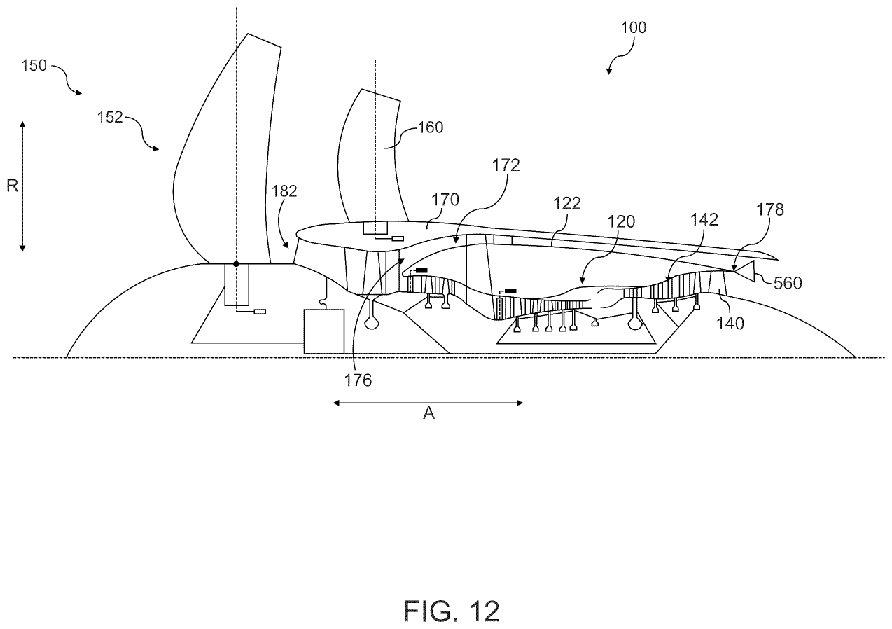

Further, still, in other exemplary embodiments, other engine configurations may be provided. For example, referring now to FIG. 12, an engine 100 in accordance with another embodiment of the present disclosure is provided. The engine 100 of FIG. 12 may be configured in a similar manner as the exemplary engine 100 of, e.g., FIGS. 1 through 3.

For example, the exemplary gas turbine engine of FIG. 12 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

However, for the embodiment of FIG. 12, the fan duct 172 of the exemplary engine 100 is an elongated fan duct 172 extending between the fan cowl 170 and the core cowl 122, a full length of the core cowl 122. With such a configuration, the fan exhaust nozzle 178 is downstream of an exhaust nozzle 140 of the turbomachine 120. The engine 100 of FIG. 12 further includes a mixing device 560 in the region aft of the exhaust nozzle 140 to aid in mixing airflow from the fan duct 172 and from a working gas flowpath 142 of the turbomachine 120, e.g., to improve acoustic performance by directing airflow from the working gas flowpath 142 of the turbomachine 120 outward and from the fan duct 172 inward. Mixing in such a manner may improve performance and noise emissions.

Moreover, in other exemplary embodiments of the present disclosure, a gas turbine engine may have still other suitable configurations. For example, in other embodiments, the gas turbine engine may include any suitable number of shafts or spools, compressors, or turbines (e.g., the gas turbine engine may be a three-spool engine having three turbines and associated spools).

Further, it will be appreciated that in at least certain exemplary embodiments of the present disclosure, a method of operating a gas turbine engine is provided. The method may be utilized with one or more of the exemplary gas turbine engines discussed herein, such as in FIGS. 1 through 12. The method includes operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5. For the exemplary method, the thrust to power airflow ratio is a ratio of an airflow through a bypass passage over a turbomachine of the gas turbine engine plus an airflow through a fan duct to an airflow through a core duct, and the core bypass ratio is a ratio of the airflow through the fan duct to the airflow through the core duct.

As will be appreciated from the description herein, various embodiments of a gas turbine engine are provided. Certain of these embodiments may be an unducted, single rotor gas turbine engine (see FIGS. 1 and 2, 11, and 12), a turboprop engine (see FIG. 6), or a ducted turbofan engine (see FIGS. 7 through 9). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects may be combined with one or more of the exemplary gas turbine engine(s) discussed above with respect to the figures.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

As such, it will be appreciated that an engine of such a configuration may be configured to generate at least 25,000 pounds and less than 80,000 of thrust during operation at a rated speed, such as between 25,000 and 50,000 pounds of thrust during operation at a rated speed, such as between 25,000 and 40,000 pounds of thrust during operation at a rated speed. Alternatively, in other exemplary aspects, an engine of the present disclosure may be configured to generate much less power, such as at least 2,000 pounds of thrust during operation at a rated speed.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R₁/R₂ may be between 1 and 10, or 2 and 7, or at least 3.3, at least 3.5, at least 4 and less than or equal to 7, where R₁ is the radius of the primary fan and R₂ is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.0 to 4.5, within a range of 4.1 to 14.0, within a range of 4.5 to 14.0, or within a range of 6.0 to 14.0. In certain embodiments, the gear ratio is within a range of 4.5 to 12 or within a range of 6.0 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 4 to 15 stages, a high-pressure turbine may include 1 to 2 stages, and/or a low pressure turbine (LPT) may include 1 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least 2. In another embodiment, L/Dcore is at least 2.5. In some embodiments, the L/Dcore is less than 5, less than 4, and less than 3. In various embodiments, it should be appreciated that the L/Dcore is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine in the embodiments depicted above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (Dcore) of the engine, L/Dcore of the engine, desired cruise altitude, and/or desired operating cruise speed, or combinations thereof.

In various additional exemplary aspects of the present disclosure, a method and system are provided for operating a gas turbine engine, and more particularly a gas turbine engine having a single stage of unducted fan blades, to achieve high advance ratios while also maintaining high net efficiency. The system includes a fan having a single stage of unducted fan blades and utilizes a specific configuration of fan blades (also referred to as rotor blades) and stationary guide vanes to provide for a desired airflow, with reduced swirl, thereby enhancing the net efficiency of the engine across various flight conditions.

In particular, the inventors of the present disclosure found that by utilizing a configuration described hereinbelow to achieve desired advanced ratios at high net efficiencies, in combination with one or more of the embodiments described hereinabove (e.g., an engine having a fan duct with particular thrust to power airflow ratios (TPAR) and core bypass ratios (CBR)) can result in an engine having unexpected and complementary benefits.

In particular, it will be appreciated that a higher advance ratio implies an operation of a primary fan at lower angular speeds, such that a secondary ducted fan that supplies pressurized air to a fan duct (third stream) runs at a lower speed as well. The lower angular speed can be used to reduce the thrust contribution of the fan duct, thereby ensuring a larger contribution from the primary fan and a higher propulsive efficiency of the primary fan. At high Mach conditions, such as cruise, high advance ratio (e.g., greater than 3.3) facilitates better performance and lower fuel burn in a three stream gas turbine engine. Additional benefits can be obtained by designing the booster, or low pressure compressor, for lower angular speed at high Mach flight than it has a low altitude and high power conditions, such as takeoff.

For a given power supplied to the primary fan, a higher advance ratio corresponds to higher torque. For a given fan frontal area, the increased torque requires higher fan solidity to maintain a desired aerodynamic loading for high efficiency. As such, solidity, as well as the product of solidity and advance ratio and the product of solidity, advance ratio, and blade count, support the performance of a three stream engine.

For example, as will be appreciated from the description hereinabove, providing the TPAR and CBR can provide for a desired airflow to a fan duct (or third stream) to ensure a desired amount of thrust is provided by the third stream to achieve a desired total engine thrust. In order to achieve a desired Advance Ratio for the engine, the airspeed and thrust needs to be increased for a given fan diameter. Combining the TPAR and CBR with the configurations described hereinbelow to achieve desired advanced ratios at high net efficiencies can enhance the engine's ability to achieve the desired Advance Ratio and net efficiency.

As will also be appreciated from the description hereinabove, providing the TPAR and CBR can provide for desired airflow to a core of the engine to enable a desired power output and efficiency from the core of the engine. Combining the configurations described hereinbelow to achieve desired advanced ratios at high net efficiencies with the TPAR and CBR of the present disclosure can ensure a sufficient amount of energy is generated by the core, while further ensuring any wasted kinetic energy is reduced in the airflow from the primary fan of the engine (e.g., through reduced swirl and improved fan blade configuration), resulting in further overall improvements in engine performance and fuel efficiency.

Moreover, a gas turbine engine of the present disclosure combining the TPAR and CBR with the configurations described hereinbelow to achieve desired advanced ratios at high net efficiencies can result in an engine having overall improvements in thermal management and lifetime structural performance. For example, the airflow ratios proscribed by the TPAR and CBR ranges of the present disclosure can allow for increased thermal management capacity for the gas turbine engine and the fan blade and stator vane arrangements of the present disclosure can reduce swirl, potentially reducing stress and wear on various engine components. The combination of improved thermal management capacity with the potential for reduced stress and wear can collectively provide for improved lifetime structural performance of various components of the gas turbine engine.

Accordingly, it will be appreciated that the integration of these technologies can provide a substantial improvement in the design and operation of gas turbine engines. The combined benefits of improved airflow ratios and advanced rotor and vane configurations open up new possibilities for enhancing engine efficiency, performance, and applicability across a range of operational scenarios.

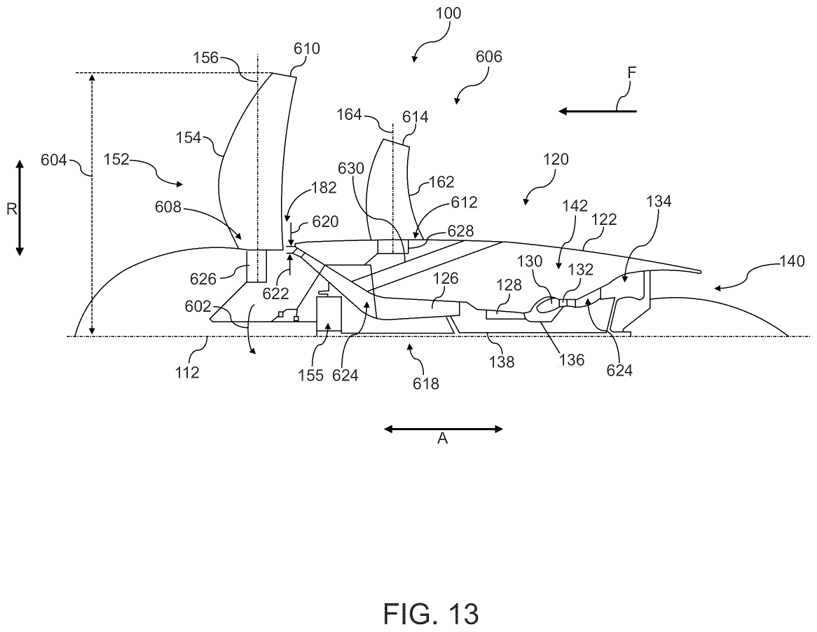

Referring now back to the drawings, FIG. 13 provides a cross-sectional view of a gas turbine engine 100 in accordance with another exemplary embodiment of the present disclosure. The exemplary gas turbine engine 100 of FIG. 13 may be configured in substantially the same manner as the exemplary gas turbine engine 100 of FIG. 1. For example, as in FIG. 1, the exemplary gas turbine engine 100 of FIG. 13 includes a rotor assembly with a single stage of unducted rotor blades. In such a manner, the rotor assembly may be referred to herein as an “unducted fan,” or the entire engine 100 may be referred to as an “unducted gas turbine engine.”

In particular, the gas turbine engine 100 includes a fan 152 (also referred to as a rotor assembly), which is an open rotor or unducted fan, and the fan includes an array of fan blades 154 rotatable, e.g., about a longitudinal axis 112. The fan 152 is configured to rotate in the circumferential direction at an angular speed during operation, as is indicated by arrow 602. A turbomachine 120 of the gas turbine engine 100 defines a fan duct 630, which may be configured in a similar manner as the fan duct 172 of, e.g., FIGS. 1-3. Although not depicted, the turbomachine 120 may include a ducted fan driven by a low pressure shaft 138, located downstream of an inlet 182 to the turbomachine 120 and upstream of an inlet to the fan duct 630.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 13 or, alternatively, may be shrouded, e.g., by an annular shroud spaced outward from the tips of the fan guide vanes 162 along the radial direction R or attached to the fan guide vanes 162.

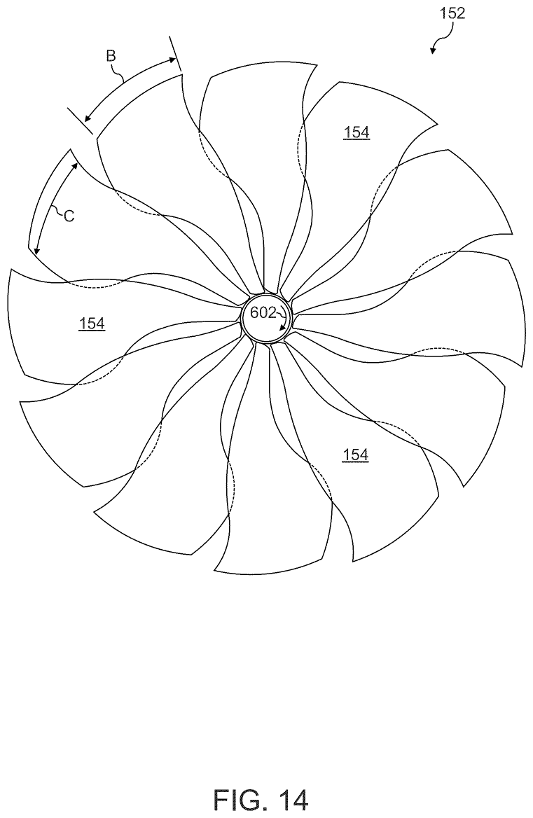

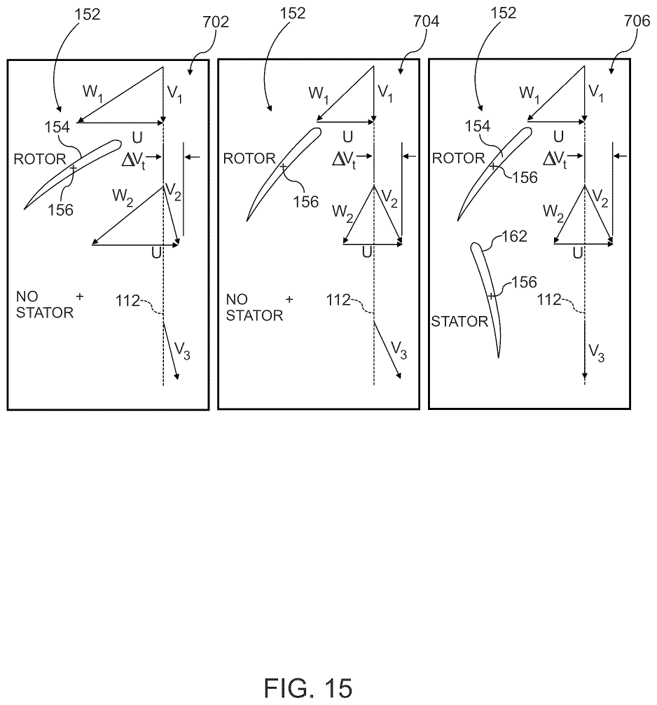

As will further be appreciated, the fan 152 defines a diameter, D, equal to two times a radius 604 shown in FIG. 13 (the same as R₁ in FIG. 1). For the embodiment show, the fan 152 may define a relatively large diameter, D, as will be described below. Moreover, additional details regarding the fan blades 154 and guide vanes 162 will be provided in the discussion below with reference to, e.g., FIG. 14.

Referring still to FIG. 13, the engine 100 further includes a turbomachine 120 having core (or high speed system) and a low speed system. The high speed system includes an HP compressor 128, an HP turbine 132, and an HP shaft 136. The low speed system includes an LP compressor 126, an LP turbine 134, and an LP shaft 138. The fan 152 is driven by the low speed system across a power gearbox 155, to generate thrust and drive the aircraft in a forward direction F.

Referring still to FIG. 13, the turbomachine 120 is generally encased in one or more cowls, including a core cowl 122 and a fan cowl 170 in the embodiment shown. Moreover, it will be appreciated that the cowls 122, 170 define at least in part the inlet 182 of the turbomachine 120 and an exhaust nozzle 140 of the turbomachine 120. The inlet 182 is for the embodiment shown an annular or axisymmetric 360 degree inlet located between the fan blades 154 and the fixed or stationary vanes 162, and provides a path for incoming atmospheric air to enter the turbomachine 120 inwardly of the guide vanes 162 along the radial direction R. Such a location may be advantageous for a variety of reasons, including management of icing performance as well as protecting the inlet 182 from various objects and materials as may be encountered in operation.

As is further indicated in FIG. 13, the inlet 182 defines an inlet area. The inlet area is defined by the equation: π(R_{OUT}²−R_{IN}²), wherein R_{OUT} is an outer measure 620 of the inlet 182 along the radial direction R, and R_{IN} is an inner measure 622 of the inlet 182 along the radial direction R. It will be appreciated that for the embodiment shown, a ratio of a frontal area (defined by an area of the fan 152, based on radius 604) to the inlet area is relatively high. Specifically, for the embodiment shown, the ratio of the frontal area to the inlet area is at least 20:1 and up to 100:1, such as up to 80:1. In such a manner, it will be appreciated that the fan 152 is relatively large as compared to the overall engine size and size of the turbomachine 120. Such may contribute to an increase in efficiency of the engine 100.

It will be appreciated, however, that in other embodiments, the inlet 182 may be positioned at any other suitable location, e.g., aft of the guide vane array 160, arranged in a non-axisymmetric manner, etc., and the fan 152 may have any other suitable size relative to the turbomachine 120 of the engine 100.

As is depicted, the fan 152 is driven by the turbomachine 120, and more specifically, is driven by the low pressure shaft 138, across a power gearbox 155. The power gearbox 155 may include a gearset for decreasing a rotational speed of the low pressure shaft 138 relative to the low speed turbine 134, such that the fan 152 may rotate at a slower rotational speed than the low pressure shaft 138. In such a manner, the rotating fan blades 154 of the fan 152 may rotate around the axis 112 and generate thrust to propel engine 100, and hence an aircraft to which it is associated, in a forward direction F.

More specifically, for the embodiment shown the power gearbox 155 defines a gear ratio for reducing the rotational speed of the fan 152 relative to the low pressure shaft 138. In at least certain exemplary embodiments, the gear ratio may be greater than or equal to about 4:1 and less than or equal to about 12:1. For example, in certain exemplary embodiments, the gear ratio may be between greater than or equal to about 7:1 and less than or equal to about 12:1. In such a case, the power gearbox 155 may be a multi-stage or compound power gearbox (e.g., a planetary gearbox having compound planet gears, etc.). Inclusion of such a high gear ratio reduction gearbox 155 may facilitate a low angular speed during operation, which may contribute to an increased efficiency of the fan 152.

It will be appreciated, however, that the exemplary single rotor unducted engine 100 depicted in FIG. 13 is by way of example only, and that in other exemplary embodiments, the engine 100 may have any other suitable configuration, including, for example, any other suitable number of shafts or spools, turbines, compressors, etc.; any suitable fixed-pitched or variable-pitched fan 152 and/or guide vane array 160; any suitable power gearbox 155 configuration, etc.

Referring now to FIG. 14 the fan 152 will be described in greater detail. FIG. 14 provides a forward-facing-aft view of the fan 152 of the exemplary engine 100 of FIG. 13. For the exemplary embodiment depicted, the fan 152 includes twelve (12) blades 154. From a loading standpoint, such a blade count may allow a span of each blade 154 to be reduced such that the overall diameter, D, of fan 152 may also be reduced (e.g., to about twelve feet in the exemplary embodiment). That said, in other embodiments, fan 152 may have any suitable blade count and any suitable diameter. In certain suitable embodiments, the fan 152 includes at least eight (8) blades 154. In another suitable embodiment, the fan 152 may have at least twelve (12) blades 154. In yet another suitable embodiment, the fan 152 may have at least fifteen (15) blades 154. In yet another suitable embodiment, the fan 152 may have at least eighteen (18) blades 154. In one or more of these embodiments, the fan 152 includes twenty-six (26) or fewer blades 154, such as twenty (20) or fewer blades 154. Further, in certain exemplary embodiments, the fan 152 may define a diameter, D, of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 16 feet.

In such a manner, it will be appreciated that the fan 152 defines a solidity, which is a conventional parameter relating the ratio of a blade chord C, as represented by its length, to a circumferential pitch B or spacing from blade to blade at the corresponding span position along the radial direction R. For example, the solidity may be equal to the average blade chord C times the number of fan blades, N, divided by the product of two (2) times pi (π) times a reference radius (Rref, which herein is a radius equal to 0.75 times a tip radius of a rotor blade, 604) [C×N/(2×π×Rref)]. For the purpose comparison, solidity is based on average blade chord defined as the blade planform area (surface area on one side of a blade) divided by the blade radial span. The solidity is directly proportional to the number of blades and chord length and inversely proportional to the diameter. For the embodiment shown, the solidity is between 0.5 and 1, such as between 0.6 and 1. However, the solidity may in other embodiments be up to about 1.5, such as up to about 1.3.

Further, it will be appreciated that the guide vane array 160 includes vanes 162 arranged in a circumferential manner, in much the same way as the fan blades 154 of the fan 152 are arranged. As such, it will further be appreciated that the guide vane array 160 may have any suitable vane count. In certain suitable embodiments, the guide vane array 160 includes at least four (4) vanes 162. In another suitable embodiment, the guide vane array 160 may have at least eight (8) vanes 162. In yet another suitable embodiment, the guide vane array 160 may have at least twelve (12) vanes 162. In yet another suitable embodiment, the guide vane array 160 may have at least eighteen (18) vanes 162. In one or more of these embodiments, the guide vane array 160 includes forty (40) or fewer vanes 162, such as twenty-six (26) or fewer vanes 162.

In various embodiments, it will be appreciated that the engine 100 includes a ratio of a quantity of vanes 162 to a quantity of blades 154 that could be less than, equal to, or greater than 1:1. For example, in certain embodiments, the engine 100 may include a ratio of a quantity of vanes 162 to a quantity of blades 154 between 1:2 and 5:2. The ratio may be tuned based on a variety of factors including a size of the vanes 162 to ensure a desired amount of swirl is removed for an airflow from the fan 152.

It should be appreciated that embodiments of the engine 100 including one or more ranges of ratios of blades 154 to vanes 31 depicted and described herein may provide advantageous improvements over open rotor gas turbine engines, turbofan gas turbine engines, or turboprop gas turbine engine configurations. In one instance, embodiments of the engine 100 provided herein may allow for thrust ranges similar to or greater than open rotor engines or turbofan engines with a larger quantities of blades or vanes, while further obviating structures such as fan cases or nacelles. In another instance, embodiments of the engine 100 provided herein allow for thrust ranges similar to or greater than turboprop engines with similar quantities of blades, while further providing reduced noise or acoustic levels such as provided herein. In still another instance, embodiments of the engine 100 provided herein may allow for thrust ranges and attenuated acoustic levels such as provided herein while reducing weight, complexity, or issues associated with fan cases, nacelles, variable nozzles, or thrust-reverser assemblies at the nacelle.

It should further be appreciated that ranges of ratios of blades 154 to vanes 31 provided herein may provide particular improvements to gas turbine engines in regard to thrust output and acoustic levels. For instance, quantities of blades greater than those of one or more ranges provided herein may produce noise levels that may disable use of an open rotor engine in certain applications (e.g., commercial aircraft, regulated noise environments, etc.). In another instance, quantities of blades less than those ranges provided herein may produce insufficient thrust output, such as to render an open rotor engine non-operable in certain aircraft applications. In yet another instance, quantities of vanes less than those of one or more ranges provided herein may fail to sufficiently produce thrust and abate noise, such as to disable use of an open rotor engine in certain applications. In still another instance, quantities of vanes greater than those of ranges provided herein may result in increased weight that adversely affects thrust output and noise abatement.

It should be appreciated that various embodiments of the single unducted rotor engine depicted and described herein may allow for normal subsonic aircraft cruise altitude operation at or above Mach 0.5. In certain embodiments, the engine 100 allows for normal aircraft operation between Mach 0.55 and Mach 0.85 at cruise altitude. In certain embodiments, the engine 100 allows for fan tip speeds (i.e., the tip speeds of the fan blades 154) at or less than 750 feet per second (fps). As will further be appreciated from the description herein, a loading of the fan blades 154 of the rotor assembly may facilitate such flight speeds.

For example, in certain exemplary embodiments, the fan blades 154 may define a power coefficient of at least 0.06 and up to 0.18 at a cruise flight condition. The term “power coefficient” as used herein refers to a measure calculated by the following formula: P/(ρ×A×V₀³), wherein “P” is power, “ρ” is ambient air density, “A” is the annular area of the propeller (fan 152), and V₀ is the flight speed. Similarly, for example, in certain exemplary embodiments, the fan blades 154 may define a thrust coefficient of at least 0.05 and up to 0.14. The term “thrust coefficient” as used herein refers to a measure calculated by the following formula: T/(ρ×A×V₀²), wherein “T” is thrust, “ρ” is ambient air density, “A” is the annular area of the propeller (fan 152), and V₀ is the flight speed. It will be appreciated that, for configurations in which the engine inlet air stream passes through the propeller, as depicted in FIG. 13, the propeller thrust, power, and annular area correspond to thrust-generating stream, i.e., the portion of the propeller air stream that is outside of the engine inlet air stream. In such a manner, it will be appreciated that the term thrust, as used herein generally refers to propeller thrust, and not engine thrust. Similarly, it will be appreciated that as used herein, the term power refers to the power of the thrust stream from the propeller, not a total propeller shaft power. It will also be appreciated that the terms thrust coefficient and power coefficient refer to non-dimensional numbers, such that the values for power, thrust, ambient air density, annular area of the propeller, and flight speed may be expressed as any suitable unit, provided the units cancel out.

Referring now to FIG. 15, rotating fan blades 154 of a fan 152 and stationary guide vanes 162 of a guide vane array 160 are depicted at a given radial location from a centerline axis 112 for various propulsor configurations. Firstly, however, it should be appreciated that a propulsion system (propulsor), such as a fan or propeller, generally generates thrust parallel to a rotational axis by transferring power from a shaft to the propulsor to accelerate the air. Power is the product of an angular speed of the shaft and a torque applied to the shaft. However, increasing the torque increases a magnitude of a tangential velocity, or swirl, imparted to the air through the propulsor. Notably, an energy in the swirl remaining in an exhaust stream of the propulsor does not contribute to a thrust generation and its kinetic energy is essentially wasted. Thus, to reduce the swirl for a given amount of power, a traditional single propeller may generally be constrained to run at relatively high angular speeds and relatively low torque levels, thereby reducing swirl. However, the inventors have found that it may be desirable to have a lower angular speed, e.g., to maintain mechanical rotational speed limits, to reduce noise generated by the blades, and/or to enable the rotor blades to operate at a higher efficiency.

To further illustrate this point, FIG. 15 depicts corresponding vector diagrams illustrating changes in air velocity over the fan blades 154 and stator vanes 162 of three separate configurations-a left panel 702, a middle panel 704, and a right panel 706. A thick end of each fan blades 154 is a leading edge. The fan blades 154 are rotatable about their pitch axes 156 and the stator vanes 162 are rotatable about their pitch axes 164. Closing the fan blades 154 is represented by a clockwise rotation of the fan blades 154 about their pitch axis 156, whereas closing the stator vanes 162 is represented by a counter-clockwise rotation of the stator vanes 162 about their pitch axis 164. In the vector diagrams, subscript “1” refers to a condition forward of the fan blades 154, “2” refers to a condition between the fan blades 154 and stator vanes 162 (if included), and “3” is a condition aft of the stator vanes 162. The letter V refers to an absolute velocity of an airflow (which may also be referred to as an airspeed when incorporated into an engine incorporated into an aircraft), W refers to a velocity relative to a rotating frame of reference of the fan 152, and U indicates a magnitude and direction of a blade speed for the rotational speed and radial location. Axial and tangential velocity components are indicated by vertical and horizontal directions. A radial component (i.e., into and out of the view in FIG. 15) is minor and ignored for the sake of explanation.

The left panel 702 illustrates a fan 152 transferring power to an airflow at a relatively high angular speed with a relatively low torque applied to the fan 152. The middle panel 704 illustrates a fan 152 with the same power as depicted in the left panel, but at a lower angular speed and with a higher torque applied thereto. As discussed above, a torque applied to the fan 152 is directly related to a change in a tangential component of the velocity V (swirl), so for a given power input, a high angular speed keeps the exit swirl at a location downstream of the fan 152 relatively small. As such, it will be appreciated that the higher torque in the middle panel 702 results in a higher exit swirl and, thus, more wasted kinetic energy.

By contrast, the right panel 706 shows a fan 152 with the addition of a stator, or guide vane array 160, with the fan 152 operating at the same power as the left and middle panels 702, 704, and with a relatively low angular speed (as is also shown in the middle panel 704). Despite the relatively low angular speed of the fan 152 and the relatively high torque applied to the fan 152 in the right panel 706, and the swirl generated by the fan 152 as a result, an exit airflow downstream of the guide vane array 160 has no significant swirl. Thus, a combination of a fan 152 and a guide vane array 160 may allow a fan 152 to be operated with a relatively high power, or rather at a relatively high power coefficient, (characterized by a relatively low angular speed and a relatively high amount of torque applied thereto), without wasting energy in the form of airflow swirl. Further, such may allow for rotation of the rotor assembly at a relatively low angular speed, which may generally translate to a higher rotor assembly efficiency.

In such a manner, it should be appreciated that a result of including the guide vane array 160 may be that the engine 100 incorporating such a fan 152 and guide vane array 160 may be operated with a more constant net efficiency over a larger range of advance ratios, as is explained below.

The net efficiency is an overall efficiency of the propulsor (e.g., the fan 152 and guide vane array 160) including the effects of friction losses and wasted kinetic energy of the stream, as well as removing the negative thrust (or adding the drag) of the spinner and casing (also referred to as the combined centerbody of the engine) for a given flight condition when the rotor blades and outlet guide vanes are not present. This may be referred to as the “blades-off” drag and is described in the American Institute of Aeronautics and Astronautics publication AIAA-1992-3770. For example, the net efficiency is generally a propulsive power (thrust multiplied by flight speed) divided by an input power. In particular, net efficiency may be characterized by the following formula: T×V₀/P; where “T” is thrust produced, “V₀” is flight speed, and “P” is power input to the rotor shaft. Net efficiency, as used herein, also refers to the net efficiency during cruise conditions for the aircraft.

Further, an advance ratio relates the true airspeed, V₀, to a rotational speed of the fan 152 and diameter, D, of the fan 152. Specifically, the advance ratio is computed accordingly to the following formula: V₀/(n×D), where “V₀” is flight speed in a length unit per second, “n” is an angular speed of the fan 152 in revolutions per second, and “D” is the diameter of the fan 152 in the same length unit used for V₀. With angular speed in the denominator, higher advance ratio values correspond to lower values of blade tip speed in comparison to the flight speed.

Further to the discussion above, it will be appreciated that an effect of including a guide vane array 160 is that an engine may extend operation of the propulsor (e.g., fan 152 and guide vane array 160) to larger advance ratios without overly degrading the net efficiency of the engine. For example, in certain exemplary embodiments, an engine operated in accordance with the present disclosure may define an advance ratio greater than or equal to about 2.8, such as greater than or equal to about 3.0, such as greater than or equal to about 3.3. For example, in certain exemplary embodiments, an engine operated in accordance with the present disclosure may define an advance ratio greater than or equal to about 3.8, such as greater than or equal to about 4.0, such as greater than or equal to about 4.2. Further, for example, in certain exemplary embodiments, an engine operated in accordance with the present disclosure may define an advance ratio up to about 9.0.

Notably, when the engine incorporates a guide vane array 160 in accordance with one or more of the exemplary embodiments described above, the engine 100 may further operate at a relatively high net efficiency for a given advance ratio. For example, in certain exemplary embodiments, the engine may be operated to define an advance ratio greater than 2.8, or 3.0, or 3.3, while also defining a net efficiency greater than or equal to 0.6, such as greater than or equal to 0.75, such as greater than or equal to 0.8, such as up to 0.9. For example, in certain exemplary embodiments, the engine may be operated to define an advance ratio greater than 3.8, while also defining a net efficiency greater than or equal to 0.6, such as greater than or equal to 0.75, such as greater than or equal to 0.8, such as up to 0.9. For example, in certain exemplary embodiments, the engine may be operated to define an advance ratio greater than 4.2, while also defining a net efficiency greater than or equal to 0.6, such as greater than or equal to 0.75, such as greater than or equal to 0.8, such as up to 0.9.

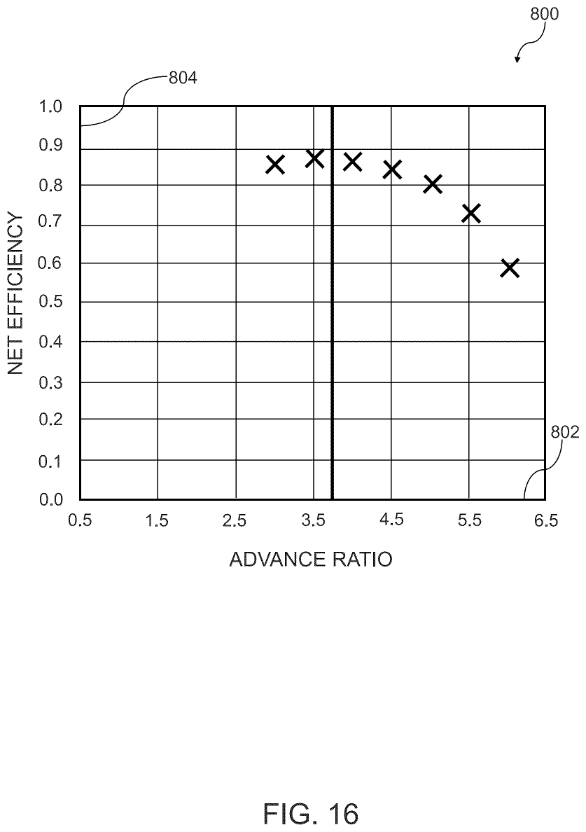

Briefly, referring now to FIG. 16, a graph 800 is depicted showing an exemplary operation of an engine in accordance with one or more exemplary embodiments of the present disclosure. The graph 800 depicts exemplary advance ratio values on the X-axis 802 and exemplary net efficiency values on the Y-axis 804. The exemplary engine may be configured in accordance with one or more of the above embodiments, and thus may be configured as a single unducted rotor engine having a stage of stationary guide vanes located relative to a single stage of unducted rotor blades to reduce a swirl in an airflow from the single stage of unducted rotor blades during operation. The graph depicts operation of the engine at relatively high flight speeds, such as greater than about Mach 0.7 and less than Mach 1, and between about Mach 0.7 and Mach 0.85. As will be appreciated, the exemplary engine configuration may allow for relatively efficient operation over a higher range of advance ratios than prior art engine configurations.

Such a benefit will further be appreciated from the following example configurations and operating conditions. These examples are provided for explanatory purposes only and are not meant to limit the scope of the present disclosure.

Example 1: An engine having a stage of unducted rotor blades defining a diameter, D, equal to 15 feet, a flight speed of approximately 765 feet per second (“fps”) true air speed during a maximum cruise operating condition, and an angular speed of the unducted rotor blades of 866 revolutions per minute (“rpm”) during the maximum cruise operating condition may define an Advance Ratio of approximately 3.5 during the maximum cruise operating condition corresponding to 37,000 feet (“ft”) altitude International Standard Atmosphere (“ISA”), 0.79 flight Mach number, 4000 pounds (“1b”) net thrust of the fan stream (according to SAE AIR 4065A), and propeller disk loading of 41 horsepower per square foot (“hp/ft²”). Also, as will be introduced below, the product of solidity and advance ratio is 2.0 and the product of blade count, solidity, and advance ratio is 20.

Example 2: An engine having a stage of unducted rotor blades defining a diameter, D, equal to 13 feet, a flight speed of approximately 765 fps true air speed during a maximum cruise operating condition, and an angular speed of the unducted rotor blades of 926 rpm during the maximum cruise operating condition may define an Advance Ratio of approximately 3.8 during the maximum cruise operating condition corresponding to 37,000 ft ISA, 0.79 flight Mach number, 4000 lb net thrust of the fan stream (according to SAE AIR 4065A), and propeller disk loading of 56 hp/ft². The product of solidity and advance ratio is 2.9 and the product of blade count, solidity, and advance ratio is 35.

Example 3: An engine having a stage of unducted rotor blades defining a diameter, D, equal to 16 feet, a flight speed of approximately 765 fps true air speed during a maximum cruise operating condition, and an angular speed of the unducted rotor blades of 477 rpm during the maximum cruise operating condition may define an Advance Ratio of approximately 6.0 during the maximum cruise operating condition corresponding to 37000 ft ISA, 0.79 flight Mach number, 4000 lb net thrust of the fan stream (according to SAE AIR 4065A), and propeller disk loading of 37 hp/ft². The product of solidity and advance ratio is 6.8 and the product of blade count, solidity, and advance ratio is 95.

In each of Examples 1, 2, and 3, the exemplary engines included a stage of unducted rotor blades having a number of rotor blades within the above ranges, and also included a stage of stationary outlet guide vanes having a number of outlet guide vanes within the above ranges. Additionally, in each of Examples 1, 2, and 3, the exemplary engines may define a loading of between 35 shaft horsepower per square feet (“SHP/ft²”) and 80 SHP/ft², such as at least 48 SHP/ft², such as at least 50 SHP/ft², such as at least 53 SHP/ft², such as at least 55 SHP/ft², such as at least 57 SHP/ft², such as up to 65 SHP/ft², such as up to 63 SHP/ft².

Further, in each of Examples 1, 2, and 3, it was determined that with these configurations the engines of Examples 1, 2, and 3 were able to achieve relatively high efficiencies at the high advance ratios. For example, the engine in Example 1 had a net efficiency of approximately 0.84, the engine in Example 2 had a net efficiency of approximately 0.83, and the engine in Example 3 had a net efficiency of approximately 0.82. Moreover, it will be appreciated that the net efficiency of the engine in Example 1 was greater than the net efficiency of the engine in Example 2, which was in turn greater than the net efficiency of the engine in Example 3.

Example 4: An engine having a stage of unducted rotor blades defining a diameter, D, equal to 11 feet and a solidity equal to about 1.46; 12 rotor blades in the stage of unducted rotor blades; 100 stator vanes in the stage of stator vanes downstream of the stage of unducted rotor blades; a flight speed of approximately 730 fps true air speed (Mach 0.75 at 35000 ft ISA) during a cruise operating condition having 4000 lb net thrust of the fan stream (according to SAE AIR 4065A) and 80 hp/ft² disk loading; and an angular speed of the unducted rotor blades of 894 rpm may define an Advance Ratio of approximately 4.5 during the maximum cruise operating condition with a net efficiency of 0.79. The product of solidity and advance ratio is 6.5 and the product of blade count, solidity, and advance ratio is 78.

Example 5: An engine having a stage of unducted rotor blades defining a diameter, D, equal to 11 feet and a solidity equal to about 1.46; 18 rotor blades in the stage of unducted rotor blades; 16 stator vanes in the stage of stator vanes downstream of the stage of unducted rotor blades; a flight speed of approximately 730 fps true air speed (Mach 0.75 at 35000 ft ISA) during a cruise operating condition; and an angular speed of the unducted rotor blades of 868 rpm may define an Advance Ratio of approximately 4.59 during the maximum cruise operating condition with a net efficiency of 0.82 having 4000 lb net thrust of the fan stream (according to SAE AIR 4065A) and 80 hp/ft² disk loading. The product of solidity and advance ratio is 6.7 and the product of blade count, solidity, and advance ratio is 121.

The above Examples are summarized in Table 1, below, which may also provide some other parameters for these examples. In this Table, D is propeller diameter measured in feet, N is the number of propeller blades, RPM is revolutions per minute, EFF is net efficiency, and J is advance ratio. In these examples, where the Mach number is 0.79, the altitude is 37,000 ft ISA, and where the Mach number is 0.75, the altitude is 35,000 ft ISA.

| Ex. # | D | N | Mach | V₀ | RPM | S | $\frac{SHP}{A}$ | $\frac{P}{ρ {AV}_{0}^{3}}$ | $\frac{T}{ρ {AV}_{0}^{2}}$ | EFF | J | S × J | N × S × J |
|---|---|---|---|---|---|---|---|---|---|---|---|---|---|
| 1 | 15 | 10 | 0.79 | 765 | 866 | 0.58 | 41 | 0.06 | 0.08 | 0.84 | 3.54 | 2.05 | 20 |
| 2 | 13 | 12 | 0.79 | 765 | 926 | 0.77 | 56 | 0.08 | 0.10 | 0.83 | 3.82 | 2.92 | 35 |
| 3 | 16 | 14 | 0.79 | 765 | 477 | 1.13 | 37 | 0.06 | 0.07 | 0.82 | 6.01 | 6.76 | 95 |
| 4 | 11 | 12 | 0.75 | 730 | 894 | 1.46 | 80 | 0.12 | 0.15 | 0.79 | 4.45 | 6.50 | 78 |
| 5 | 11 | 18 | 0.75 | 730 | 868 | 1.47 | 78 | 0.12 | 0.15 | 0.81 | 4.59 | 6.74 | 121 |

It has been found that by considering the product of the solidity, S, and advance ratio, J, there are unexpected benefits realized in terms of an overall design of a propulsive system (e.g., turbofan engine) especially well-suited for operating at a relatively high advance ratio with acceptable net efficiency at cruise conditions. For example, the product S×J can inform the skilled artisan of an operating space, which includes designing towards a more compact and higher loaded rotor of the propulsion system. The product S×J indicates a range of values, according to at least some embodiments, producing high values of advance ratio with acceptable net efficiency while also indicating the type of rotor design that should be selected. This rotor design indication is intended to mean such things as the dimensions or qualities of the rotor blades that are believed reasonable and practical for a rotor operating at high advance ratios. In other words, the product S×J indicates not only the operating range of interest, but also the type of rotor that is believed to provide superior results, given the constraints within which a rotor of a propulsive system may be selected, e.g., size, dimensions, weight of rotor blades, mission requirements, airframe type, etc. In still other embodiments, the product S×J×N may also, or alternatively be used to define the propulsive system operating at a relatively high advance ratio with acceptable net efficiency at cruise. N represents the number of blades for the rotor. By also considering the number of blades, one may account for a change in blade shed vorticity, which influences the net efficiency. Additionally, for a given advance ratio, an increase in N may positively affect the acoustic environment when the rotor is operating at cruise conditions. Such things as a propulsive system's requirements, its subsystem requirements, airframe integration needs and limitations, and performance capabilities may therefore be defined by the product of S and J, and optionally S, J and N.

In view of the foregoing objectives, in at least certain embodiments, a propulsion system is configured to define a S×J greater than 2.0, such as greater than 3.8, such as greater than 4.4, such as at least 6.0, up to 8.0.

In view of the foregoing objectives, in at least certain embodiments, a propulsion system is configured to define a S×J×N greater than 16, such as greater than 50, such as greater than 50, such as at least 72, and up to 150.

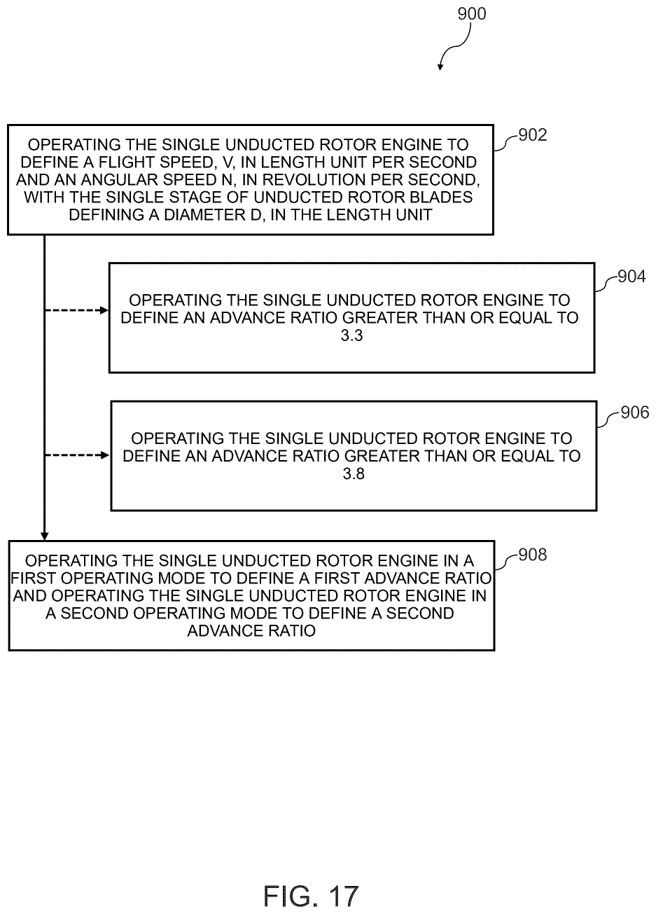

Referring now to FIG. 17, a flow diagram is provided of a method 900 for operating a single unducted rotor engine in accordance with an exemplary aspect of the present disclosure. In at least certain exemplary aspects, the method 900 may be used with one or more of the exemplary single unducted rotor engines described above with respect to FIGS. 13 through 16. As such, it will be appreciated that in at least certain exemplary aspects, the single unducted rotor engine may generally include a single stage of unducted rotor blades.

The method 900 includes at (902) operating the single unducted rotor engine to define a flight speed, V₀, in a length unit per second and an angular speed, n, in revolutions per second, with the single stage of unducted rotor blades defining a diameter, D, in the length unit. Operating the single unducted rotor engine at (902) may include operating an aircraft to define such a flight speed. Moreover, operating the single unducted rotor engine at (902) may include operating the single unducted rotor engine during powered operating conditions. As used herein, “powered” operating conditions refer to any anticipated powered operations of the engine (e.g., idle, cruise, climb, takeoff, etc.), but excludes any conditions wherein the engine isn't providing thrust (such as during a failure condition wherein the engine is windmilling).

In one exemplary aspect, the single unducted rotor engine may further include a stage of stationary guide vanes for reducing a swirl in an airflow from the single stage of unducted rotor blades. With such an exemplary aspect, operating the single unducted rotor engine at (902) may further include at (904) operating the single unducted rotor engine to define an advance ratio greater than or equal to about 3.3.

Additionally, or alternatively, operating the single unducted rotor engine at (902) may include at (906) operating the single unducted rotor engine to define an advance ratio greater than or equal to 3.8. For example, in certain exemplary aspects, operating the single unducted rotor engine at (902) may include operating the single unducted rotor engine to define an advance ratio greater than or equal to 3.8, or 4.0, such as greater than or equal to 4.2, such as less than or equal to about 9.0.

Referring still to FIG. 17, it will further be appreciated that for the exemplary aspect of the method 900 depicted in FIG. 17, operating the single unducted rotor engine at (902) further includes at (908) operating the single unducted rotor engine in a first operating mode to define a first advance ratio and operating the single unducted rotor engine in a second operating mode to define a second advance ratio. In at least certain exemplary aspects, the first operating mode may be a low flight speed operating mode and the second operating mode may be a high flight speed operating mode. With such an exemplary aspect, the first advance ratio may be less than the second advance ratio, with each greater than or equal to 3.3, or with each greater than or equal to 3.8, etc.

For example, in certain exemplary aspects, the first operating mode may be a cruise operating mode and the second operating mode may be a takeoff/climb operating mode. Additionally, or alternatively, the first operating mode may be a descent operating mode in the second operating mode may be a cruise operating mode.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine comprising: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine; and a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct.

The gas turbine engine of any preceding clause, wherein the thrust to power airflow ratio and the core bypass ratio are defined when the gas turbine engine is operated at a rated speed during standard day operating conditions.

The gas turbine engine of any preceding clause, wherein the thrust to power airflow ratio between 4 and 75.

The gas turbine engine of any preceding clause, wherein the primary fan is an unducted primary fan, and wherein the thrust to power airflow ratio between 30 and 60.

The gas turbine engine of any preceding clause, wherein the thrust to power airflow ratio between 35 and 50.

The gas turbine engine of any preceding clause, wherein the core bypass ratio between 0.3 and 5.

The gas turbine engine of any preceding clause, wherein the gas turbine engine is a turboprop engine, and wherein the thrust to power airflow ratio between 40 and 100.

The gas turbine engine of any preceding clause, wherein the primary fan is a ducted primary fan, and wherein the thrust to power airflow ratio is between 3.5 and 40.

The gas turbine engine of any preceding clause, wherein the gas turbine engine is a direct drive gas turbine engine, and wherein the thrust to power airflow ratio is between 3.5 and 20.

The gas turbine engine of any preceding clause, wherein the gas turbine engine is a geared gas turbine engine, and wherein the thrust to power airflow ratio is between 8 and 40.

The gas turbine engine of any preceding clause, wherein the secondary fan is a single stage secondary fan.

The gas turbine engine of any preceding clause, wherein the secondary fan is a multi-stage secondary fan.

The gas turbine engine of any preceding clause, wherein the multi-stage secondary fan is a two stage secondary fan.

The gas turbine engine of any preceding clause, wherein the primary fan is a ducted primary fan comprising an outer nacelle surrounding the primary fan and defining the bypass passage downstream of the primary fan and over the turbomachine, wherein the gas turbine engine further defines a bypass passage outlet at a downstream end of the outer nacelle, wherein the fan duct defines a fan duct outlet, and wherein the fan duct outlet is downstream of the bypass passage outlet.

The gas turbine engine of any preceding clause, wherein the primary fan is a ducted primary fan comprising an outer nacelle surrounding the primary fan and defining the bypass passage downstream of the primary fan and over the turbomachine, wherein the gas turbine engine further defines a bypass passage outlet at a downstream end of the outer nacelle, wherein the fan duct defines a fan duct outlet, and wherein the fan duct outlet is upstream of the bypass passage outlet.

The gas turbine engine of any preceding clause, wherein the primary fan, the secondary fan, the compressor section, the combustion section, and the turbine section are arranged in serial flow order.

A method of operating a gas turbine engine, comprising: operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5, wherein the thrust to power airflow ratio is a ratio of an airflow through a bypass passage over a turbomachine of the gas turbine engine plus an airflow through a fan duct to an airflow through a core duct, and wherein the core bypass ratio is a ratio of the airflow through the fan duct to the airflow through the core duct.

The method of any preceding clause, wherein the thrust to power airflow ratio between 4 and 75.

The method of any preceding clause, wherein the primary fan is an unducted primary fan, and wherein the thrust to power airflow ratio between 30 and 60.

The method of any preceding clause, wherein the thrust to power airflow ratio between 35 and 50.

The method of any preceding clause, wherein the core bypass ratio between 0.3 and 5.

A method of operating a single unducted rotor engine, the single unducted rotor engine comprising a single stage of unducted rotor blades, the method comprising: operating the single unducted rotor engine to define a flight speed, V₀, in a length unit per second and an angular speed, n, in revolutions per second, the single stage of unducted rotor blades defining a diameter, D, in the length unit; wherein operating the single unducted rotor engine comprises operating the single unducted rotor engine to define an advance ratio greater than 2.8, 3.0, 3.3, or 3.8 while operating the single unducted rotor engine at a net efficiency of at least 0.8, the advance ratio defined by the equation V₀/(n×D).

The method of one or more of these clauses, wherein operating the single unducted rotor engine to define the advance ratio greater than 3.8 comprises operating the single unducted rotor engine to define the advance ratio greater than 4.0.

The method of one or more of these clauses, wherein operating the single unducted rotor engine to define the advance ratio greater than 3.8 comprises operating the single unducted rotor engine to define the advance ratio greater than 4.2.

The method of one or more of these clauses, wherein operating the single unducted rotor engine to define the advance ratio greater than 3.8 comprises operating the single unducted rotor engine to define the advance ratio greater than 3.8 and less than 9.0.

The method of one or more of these clauses, wherein the single stage of unducted rotor blades comprises at least 8 unducted rotor blades and less than 26 unducted rotor blades.

The method of claim 1, wherein the single stage of unducted rotor blades defines a solidity between 0.5 and 1.0.

The method of one or more of these clauses, wherein the single unducted rotor engine further comprises a stage of stationary guide vanes having a plurality of stationary guide vanes located downstream of the single stage of unducted rotor blades for reducing a swirl in an airflow from the single stage of unducted rotor blades.

The method of one or more of these clauses, wherein a ratio of the number of stationary guide vanes in the stage of stationary guide vanes to the number of unducted rotor blades in the single stage of unducted rotor blades is at least 1:2 and up to 5:2

The method of one or more of these clauses, wherein the single unducted rotor engine comprises a turbine section having a turbine, a shaft rotatable with the turbine, and a reduction gearbox, wherein the single stage of unducted rotor blades is driven by the shaft across the reduction gearbox, and wherein the reduction gearbox defines a gear ratio of at least 7:1.

The method of one or more of these clauses, wherein the single unducted rotor engine comprises a turbomachine defining an inlet having an inlet area, wherein the single stage of unducted rotor blades defines a frontal area, and wherein a ratio of the frontal area to the inlet area is less than about 100:1 and at least 20:1.

The method of one or more of these clauses, wherein operating the single unducted rotor engine to define the advance ratio greater than 3.8 comprises operating the single unducted rotor engine in a first operating mode to define a first advance ratio and operating the single unducted rotor engine in a second operating mode to define a second advance ratio.

The method of one or more of these clauses, wherein the first operating mode is a low flight speed operating mode and wherein the second operating mode is a high flight speed operating mode, and wherein the first advance ratio is less than the second advance ratio.

The method of one or more of these clauses, wherein operating the single unducted rotor engine to define the advance ratio greater than 3.8 comprises operating the single unducted rotor engine at a net efficiency of up to 0.9.

The method of one or more of these clauses, wherein operating the single unducted rotor engine to define the advance ratio greater than 3.8 comprises operating the single unducted rotor engine with a power coefficient of at least 0.06 and up to 0.18 at a cruise flight condition, with a thrust coefficient of at least 0.05 and up to 0.14, or both.

The method of one or more of these clauses, comprising operating the engine in accordance is the parameters of Example 1 in Table 1.

The method of one or more of these clauses, comprising operating the engine in accordance is the parameters of Example 2 in Table 1.

The method of one or more of these clauses, comprising operating the engine in accordance is the parameters of Example 3 in Table 1.

The method of one or more of these clauses, comprising operating the engine in accordance is the parameters of Example 4 in Table 1.

The method of one or more of these clauses, comprising operating the engine in accordance is the parameters of Example 5 in Table 1.

The method of one or more of these clauses, comprising operating the engine to define parameters ranging between at least two of the Examples in Table 1.

A single unducted rotor engine comprising: a turbomachine; and an unducted rotor assembly driven by the turbomachine comprising a single row of a plurality of rotor blades, the plurality of rotor blades defining a diameter, D; wherein the single unducted rotor engine is configured to be operated to define a flight speed flight speed, V, measured in a length unit per second and an angular speed, n, measured in revolutions per second, wherein during operation the single unducted rotor engine is configured to define an advance ratio greater than 3.8 and a net efficiency of at least 0.8, the advance ratio defined by the equation V₀/(n×D).

The single unducted rotor engine of one or more of these clauses, wherein an outlet guide vane assembly comprising a plurality of outlet guide vanes located relative to the plurality of rotor blades for reducing a swirl in an airflow from the plurality of rotor blades.

The single unducted rotor engine of one or more of these clauses, wherein a ratio of the number of stationary guide vanes in the stage of stationary guide vanes to the number of unducted rotor blades in the single stage of unducted rotor blades is at least 1:2 and up to 5:2.

The single unducted rotor engine of one or more of these clauses, wherein a ratio of the number of stationary guide vanes in the stage of stationary guide vanes to the number of unducted rotor blades in the single stage of unducted rotor blades is 1:1.

The single unducted rotor engine of one or more of these clauses, wherein the turbomachine of the single unducted rotor engine comprises a turbine section having a turbine, a shaft rotatable with the turbine, and a reduction gearbox, wherein the unducted rotor assembly is driven by the shaft across the reduction gearbox, and wherein the reduction gearbox defines a gear ratio of at least 7:1.

A single unducted rotor engine comprising: a turbomachine; and an unducted rotor assembly driven by the turbomachine comprising a single row of a plurality of rotor blades, the single row of rotor blades comprising a total number of rotor blades, N, wherein the single unducted rotor engine defines a product of advance ratio and solidity of greater than 2.0; optionally greater than 2.9 and up to 8; optionally between about 1.8 and 3.5, optionally between about 3.2 and 6.5, and optionally between 4 and 5.

A single unducted rotor engine comprising: a turbomachine; and an unducted rotor assembly driven by the turbomachine comprising a single row of a plurality of rotor blades, the single row of rotor blades comprising a total number of rotor blades, N, wherein the single unducted rotor engine defines a product of advance ratio, N, and solidity of 16, optionally greater than 60, and up to 150, between 16 and 47, optionally between 51 and 92, and optionally between 40 and 75.

The single unducted rotor engine of one or more of these clauses, wherein a ratio of the number of stationary guide vanes in the stage of stationary guide vanes to the number of unducted rotor blades in the single stage of unducted rotor blades is at least 1:2 and up to 5:2.

The single unducted rotor engine of one or more of these clauses, wherein S*J is greater than 2.0, and wherein during operation the single unducted rotor engine is configured to define a net efficiency of at least 0.8.

The single unducted rotor engine of one or more of these clauses, wherein the solidity is between 0.5 and 1, such as between 0.6 and 1.

The single unducted rotor engine of one or more of these clauses, wherein the solidity is up to about 1.5, such as up to about 1.3.

The single unducted rotor engine of one or more of these clauses, wherein the advance ratio is greater than 3.8, such as greater than 4.0, such as greater than 4.2, such as greater than 4.5, such as greater than 4.7, such as greater than 5.0.

The single unducted rotor engine of one or more of these clauses, wherein the advance ratio is greater than about 3.8, such as greater than about 4.0, such as greater than about 4.2, such as greater than about 4.5, such as greater than about 4.7, such as greater than about 5.0, and wherein the solidity is greater than about 0.5, such as greater than about 0.7, such greater than about 0.9, such as greater than about 1.0, such as up to about 1.5, such as up to about 1.3.

The single unducted rotor engine of one or more of these clauses operated in accordance with a method of one or more of these clauses.

The single unducted rotor engine of one or more of these clauses, wherein the engine defines the parameters of Example 1 in Table 1.

The single unducted rotor engine of one or more of these clauses, wherein the engine defines the parameters of Example 2 in Table 1.

The single unducted rotor engine of one or more of these clauses, wherein the engine defines the parameters of Example 3 in Table 1.

The single unducted rotor engine of one or more of these clauses, wherein the engine defines the parameters of Example 4 in Table 1.

The single unducted rotor engine of one or more of these clauses, wherein the engine defines the parameters of Example 5 in Table 1.

The single unducted rotor engine of one or more of these clauses, wherein the engine defines parameters in a range bounded by two of the examples in Table 1.

The method of one or more of these clauses utilizing a single unducted rotor engine of one or more of these clauses.

A method of operating a propulsive system having a single unducted rotor, the propulsive system comprising a single stage of unducted rotor blades, the method comprising: operating the propulsive system to define a flight speed, V₀, in a length unit per second and an angular speed, n, in revolutions per second, the single stage of unducted rotor blades defining a diameter, D, in the length unit; wherein operating the propulsive system comprises operating the single unducted rotor engine to define an advance ratio greater than 3.8 while operating the single unducted rotor engine at a net efficiency of at least 0.8, the advance ratio defined by the equation V₀/(n×D).

A propulsive system having a single unducted rotor, comprising: a propulsor; and an unducted rotor assembly driven by the propulsor comprising a single row of a plurality of rotor blades, wherein the single unducted rotor engine is configured to define a product of advance ratio and solidity of greater than 2.0; optionally greater than 3.8; optionally greater than 5.0; optionally between 2.5 and 8.0.

A method of operating a propulsive system having a single unducted rotor, the propulsive system comprising a single stage of unducted rotor blades, the method comprising: operating the propulsive system to define a flight speed, V₀, in a length unit per second and an angular speed, n, in revolutions per second, the single stage of unducted rotor blades defining a diameter, D, in the length unit; wherein operating the propulsive system comprises operating the single unducted rotor engine to define an advance ratio greater than 3.8 while operating the single unducted rotor engine at a net efficiency of at least 0.8, the advance ratio defined by the equation V₀/(n×D).

A propulsive system having a single unducted rotor, comprising: a propulsor; and an unducted rotor assembly driven by the propulsor comprising a single row of a plurality of rotor blades, wherein the single unducted rotor engine is configured to define a product of advance ratio, number of the rotor blades, and solidity of about 6 up to about 150.

The propulsive system of one or more of these clauses, wherein a ratio of the number of stationary guide vanes in the stage of stationary guide vanes to the number of unducted rotor blades in the single stage of unducted rotor blades is at least 1:2 and up to 5:2.

The propulsive system of one or more of these clauses, wherein S*J is greater than 2.0, and wherein during operation the propulsive system is configured to define a net efficiency of at least 0.8.

The propulsive system of one or more of these clauses, wherein the solidity is between 0.5 and 1, such as between 0.6 and 1.

The propulsive system of one or more of these clauses, wherein the solidity is up to about 1.5, such as up to about 1.3.

The propulsive system of one or more of these clauses, wherein the advance ratio is greater than 3.8, such as greater than 4.0, such as greater than 4.2, such as greater than 4.5, such as greater than 4.7, such as greater than 5.0.

The propulsive system of one or more of these clauses, wherein the advance ratio is greater than about 3.8, such as greater than about 4.0, such as greater than about 4.2, such as greater than about 4.5, such as greater than about 4.7, such as greater than about 5.0, and wherein the solidity is greater than about 0.5, such as greater than about 0.7, such greater than about 0.9, such as greater than about 1.0, such as up to about 1.5, such as up to about 1.3.

The propulsive system of one or more of these clauses operated in accordance with a method of one or more of these clauses.

The method of one or more of these clauses utilizing a propulsive system of one or more of these clauses.

A gas turbine engine comprising: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine; and a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct, wherein during operation of the gas turbine engine in an operating condition, the gas turbine engine defines an advance ratio greater than 3.3 and less than 9.0 and a net efficiency of at least 0.8 and less than 1.

The gas turbine engine of one or more of these clauses, wherein the primary fan defines a diameter, D, in a length unit, and wherein during operation of the gas turbine engine in the operating condition, the gas turbine engine defines a flight speed, V₀, in the length unit per second and the primary fan defines an angular speed, n, in revolutions per second, and wherein the advance ratio defined by the equation V₀/(n×D).

The gas turbine engine of one or more of these clauses, wherein during operation of the gas turbine engine in the operating condition, the advance ratio defined by the gas turbine engine is greater than 3.8.

The gas turbine engine of one or more of these clauses, wherein the primary fan comprises a single stage of unducted fan blades, wherein the single stage of unducted fan blades comprises at least 8 unducted fan blades and less than 26 unducted fan blades.

The gas turbine engine of one or more of these clauses, wherein the primary fan comprises a single stage of unducted fan blades, wherein the single stage of unducted fan blades defines a solidity between 0.5 and 1.0.

The gas turbine engine of one or more of these clauses, wherein the gas turbine engine defines a product of advance ratio and solidity of greater than 2.0 and less than 8.5.

The gas turbine engine of one or more of these clauses, wherein the gas turbine engine comprises an outlet guide vane assembly including a plurality of outlet guide vanes located relative to the plurality of rotor blades for reducing a swirl in an airflow from the plurality of rotor blades.

A gas turbine engine comprising: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine defining a solidity; and a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct, wherein during operation of the gas turbine engine in an operating condition, the gas turbine engine defines a product of an advance ratio and the solidity of greater than 2.0 and less than 8.5.

The gas turbine engine of one or more of these clauses, wherein the gas turbine engine comprises an outlet guide vane assembly including a plurality of outlet guide vanes located relative to the plurality of rotor blades for reducing a swirl in an airflow from the plurality of rotor blades.

The gas turbine engine of one or more of these clauses, wherein during operation of the gas turbine engine in an operating condition, the gas turbine engine defines an advance ratio greater than 3.4 and less than 9.0 and a net efficiency of at least 0.8 and less than 1.

The gas turbine engine of one or more of these clauses, wherein the primary fan defines a diameter, D, in a length unit, and wherein during operation of the gas turbine engine in the operating condition, the gas turbine engine defines a flight speed, V₀, in the length unit per second and the primary fan defines an angular speed, n, in revolutions per second, and wherein the advance ratio defined by the equation V₀/(n×D).

The gas turbine engine of one or more of these clauses, wherein during operation of the gas turbine engine in the operating condition, the advance ratio defined by the gas turbine engine is greater than 3.8.

The gas turbine engine of one or more of these clauses, wherein the primary fan comprises a single stage of unducted fan blades, wherein the single stage of unducted fan blades comprises at least 8 unducted fan blades and less than 26 unducted fan blades.

The gas turbine engine of one or more of these clauses, wherein the primary fan comprises a single stage of unducted fan blades, wherein the solidity defined by the single stage of unducted fan blades is between 0.5 and 1.0.

The gas turbine engine of one or more of these clauses, wherein the thrust to power airflow ratio and the core bypass ratio are defined when the gas turbine engine is operated at a rated speed during standard day operating conditions.

The gas turbine engine of one or more of these clauses, wherein the primary fan is an unducted primary fan, and wherein the thrust to power airflow ratio is between 30 and 60.

A method of operating a gas turbine engine, comprising: operating the gas turbine engine at a rated speed, wherein operating the gas turbine engine at the rated speed comprises operating the gas turbine engine to define a thrust to power airflow ratio between 3.5 and 100, a core bypass ratio between 0.1 and 5, and an advance ratio greater than 3.3 and less than 9.0, wherein the thrust to power airflow ratio is a ratio of an airflow through a bypass passage over a turbomachine of the gas turbine engine plus an airflow through a fan duct to an airflow through a core duct, and wherein the core bypass ratio is a ratio of the airflow through the fan duct to the airflow through the core duct.

The method of one or more of these clauses, wherein the primary fan defines a diameter, D, in a length unit, and wherein operating the gas turbine engine at the rated speed further comprises operating the gas turbine engine to define a flight speed, V₀, in the length unit per second and an angular speed, n, of the primary fan in revolutions per second, and wherein the advance ratio defined by the equation V₀/(n×D).

The method of one or more of these clauses, wherein the advance ratio is greater than 3.8.

The method of one or more of these clauses, wherein the primary fan defines a solidity, and wherein operating the gas turbine engine at the rated speed further comprises operating the gas turbine engine to define a product of the advance ratio and the solidity of greater than 2.0 and less than 8.5.

We claim:

1. A gas turbine engine comprising:
a turbomachine comprising a compressor section, a combustion section, and a turbine section arranged in serial flow order, the turbomachine defining an engine inlet to an inlet duct, a fan duct inlet to a fan duct, and a core inlet to a core duct;
a primary fan driven by the turbomachine; and
a secondary fan located downstream of the primary fan within the inlet duct,
the gas turbine engine defining a thrust to power airflow ratio between 3.5 and 100 and a core bypass ratio between 0.1 and 10,
wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct,
wherein during operation of the gas turbine engine in an operating condition, the gas turbine engine defines an advance ratio greater than 3.3 and less than 9.0 and a net efficiency of at least 0.8 and less than 1.

2. The gas turbine engine of claim 1, wherein the primary fan defines a diameter, D, in a length unit, and wherein during operation of the gas turbine engine in the operating condition, the gas turbine engine defines a flight speed, V₀, in the length unit per second and the primary fan defines an angular speed, n, in revolutions per second, and wherein the advance ratio defined by the equation V₀/(n×D).

3. The gas turbine engine of claim 1, wherein during operation of the gas turbine engine in the operating condition, the advance ratio defined by the gas turbine engine is greater than 3.8.

4. The gas turbine engine of claim 1, wherein the primary fan comprises a single stage of unducted fan blades, wherein the single stage of unducted fan blades comprises at least 8 unducted fan blades and less than 26 unducted fan blades.

5. The gas turbine engine of claim 1, wherein the primary fan comprises a single stage of unducted fan blades, wherein the single stage of unducted fan blades defines a solidity between 0.5 and 1.0.

6. The gas turbine engine of claim 1, wherein the gas turbine engine defines a product of advance ratio and solidity of greater than 2.0 and less than 8.5.

7. The gas turbine engine of claim 1, wherein the gas turbine engine comprises an outlet guide vane assembly including a plurality of outlet guide vanes located relative to the plurality of rotor blades for reducing a swirl in an airflow from the plurality of rotor blades.

8. A gas turbine engine comprising:
a turbomachine comprising a compressor section, a combustion section, and a turbine section arranged in serial flow order, the turbomachine defining an engine inlet to an inlet duct, a fan duct inlet to a fan duct, and a core inlet to a core duct;
a primary fan driven by the turbomachine defining a solidity; and
a secondary fan located downstream of the primary fan within the inlet duct,
the gas turbine engine defining a thrust to power airflow ratio between 3.5 and 100 and a core bypass ratio between 0.1 and 10,
wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct,
wherein during operation of the gas turbine engine in an operating condition, the gas turbine engine defines a product of an advance ratio and the solidity of greater than 2.0 and less than 8.5.

9. The gas turbine engine of claim 8, wherein the gas turbine engine comprises an outlet guide vane assembly including a plurality of outlet guide vanes located relative to the plurality of rotor blades for reducing a swirl in an airflow from the plurality of rotor blades.

10. The gas turbine engine of claim 8, wherein during operation of the gas turbine engine in an operating condition, the gas turbine engine defines an advance ratio greater than 3.4 and less than 9.0 and a net efficiency of at least 0.8 and less than 1.

11. The gas turbine engine of claim 10, wherein the primary fan defines a diameter, D, in a length unit, and wherein during operation of the gas turbine engine in the operating condition, the gas turbine engine defines a flight speed, V₀, in the length unit per second and the primary fan defines an angular speed, n, in revolutions per second, and wherein the advance ratio defined by the equation V₀/(n×D).

12. The gas turbine engine of claim 10, wherein during operation of the gas turbine engine in the operating condition, the advance ratio defined by the gas turbine engine is greater than 3.8.

13. The gas turbine engine of claim 8, wherein the primary fan comprises a single stage of unducted fan blades, wherein the single stage of unducted fan blades comprises at least 8 unducted fan blades and less than 26 unducted fan blades.

14. The gas turbine engine of claim 8, wherein the primary fan comprises a single stage of unducted fan blades, wherein the solidity defined by the single stage of unducted fan blades is between 0.5 and 1.0.

15. The gas turbine engine of claim 8, wherein the thrust to power airflow ratio and the core bypass ratio are defined when the gas turbine engine is operated at a rated speed during standard day operating conditions.

16. The gas turbine engine of claim 1, wherein the primary fan is an unducted primary fan, and wherein the thrust to power airflow ratio is between 30 and 60.

17. A method of operating a gas turbine engine, comprising:
operating the gas turbine engine at a rated speed, wherein operating the gas turbine engine at the rated speed comprises operating the gas turbine engine to define a thrust to power airflow ratio between 3.5 and 100, a core bypass ratio between 0.1 and 5, and an advance ratio greater than 3.3 and less than 9.0,
wherein the thrust to power airflow ratio is a ratio of an airflow through a bypass passage over a turbomachine of the gas turbine engine plus an airflow through a fan duct to an airflow through a core duct, and wherein the core bypass ratio is a ratio of the airflow through the fan duct to the airflow through the core duct.

18. The method of claim 17, wherein the primary fan defines a diameter, D, in a length unit, and wherein operating the gas turbine engine at the rated speed further comprises operating the gas turbine engine to define a flight speed, V₀, in the length unit per second and an angular speed, n, of the primary fan in revolutions per second, and wherein the advance ratio defined by the equation V₀/(n×D).

19. The method of claim 17, wherein the advance ratio is greater than 3.8.

20. The method of claim 17, wherein the primary fan defines a solidity, and wherein operating the gas turbine engine at the rated speed further comprises operating the gas turbine engine to define a product of the advance ratio and the solidity of greater than 2.0 and less than 8.5.
